(19) United States
(12) Patent Application Publication
(10) Pub. No.: US 2026/0049226 A1
(43) Pub. Date: Feb. 19, 2026

(54) COATED OPTICAL SUBSTRATES AND METHODS OF PRODUCTION THEREOF

(71) Applicant: FLO OPTICS LTD., Petah Tikva (IL)

(72) Inventors: Claudio ROTTMAN SAVION, Petach Tikva (IL); Vitaly KRAKOV, Arad (IL); Ilan HIDANA, Katzir (IL); Vered ITALIANO, Kfar Ben Nun (IL); Shalom LAMPERT, Maalot (IL)

(21) Appl. No.: 19/366,855

(22) Filed: Oct. 23, 2025

Related U.S. Application Data
(63) Continuation-in-part of application No. PCT/IB2024/053962, filed on Apr. 23, 2024.

(30) Foreign Application Priority Data
Apr. 23, 2023 (GB) 2305935.5

(51) Int. Cl. C09D 11/50; C09D 11/38; C09D 11/54; G02C 7/10

(52) U.S. Cl. CPC C09D 11/50; C09D 11/38; C09D 11/54; G02C 7/102

(57) ABSTRACT

A method of producing an ophthalmic construction, comprising: (a) depositing a wet recipience layer on an ophthalmic surface of an ophthalmic substrate; (b) after the wet recipience layer has cured to form an at least partially cured, recipience layer, applying, onto a recipience surface of the recipience layer: a first photochromic dye disposed in a first photochromic ink containing a first liquid medium, and at least a first softening agent adapted to soften the recipience layer; and (c) after the at least one photochromic ink has at least partially penetrated the upper surface of the recipience layer, and after the first photochromic ink has at least partially dried to form a photochromic dye containing recipience layer, applying a first polymer formulation on the photochromic dye containing recipience layer to form an overcoat layer.

### CROSS-REFERENCE TO RELATED APPLICATIONS

This patent application is a continuation-in-part of PCT/IB2024/053962, filed on Apr. 23, 2024, which is incorporated herein by reference in its entirety.

### FIELD AND BACKGROUND OF THE INVENTION

The present invention relates to coated optical and ophthalmic devices, such as a lens, having at least one layer of photochromic coating, and to methods of producing such optical and ophthalmic apparatus.

Coated optical substrates often contain at least one photochromic dye. Such dyes typically change color—reversibly—in response to ultraviolet light, usually turning clear in the absence of sunlight or other source of ultraviolet light. In this photochromic transition, the photochromic dye undergoes a reversible photochemical reaction in which an absorption band in the visible part of the electromagnetic spectrum changes in strength or wavelength. For practical use in optical coatings, the properties of the photochromic material must satisfy numerous performance criteria, conditions and constraints.

The present inventors have recognized a need for improved optical and ophthalmic apparatus having at least one layer of photochromic coating, as well as a need for improved methods of producing such optical and ophthalmic apparatus.

### SUMMARY OF THE INVENTION

According to some teachings of the present invention there is provided a method of producing an ophthalmic construction, the method comprising: (a) depositing a wet recipience layer on an ophthalmic surface of an ophthalmic substrate; (b) after the wet recipience layer has cured to form an at least partially cured, recipience layer, applying, onto a recipience surface of the recipience layer: a first photochromic dye disposed in a first photochromic ink containing a first liquid medium, and at least a first softening agent adapted to soften the recipience layer; and (c) after the at least one photochromic ink has at least partially penetrated the upper surface of the recipience layer, and after the first photochromic ink has at least partially dried to form a photochromic dye containing recipience layer, applying a first polymer formulation on the photochromic dye containing recipience layer to form an overcoat layer.

According to further teachings of the present invention there is provided a method of producing an ophthalmic construction, the method comprising: (a) depositing a wet recipience layer on an ophthalmic surface of an ophthalmic substrate; (b) after the wet recipience layer has cured to form an at least partially cured, recipience layer, applying at least a first photochromic ink, onto a recipience surface of the recipience layer; wherein the first photochromic ink contains a first photochromic dye disposed within a first liquid medium, and a softening agent adapted to soften the recipience layer; (c) optionally, after the wet recipience layer has cured to form the at least partially cured, recipience layer, applying, onto the recipience surface, at least a second photochromic ink containing a second photochromic dye disposed within a second liquid medium; and (d) after the at least a first photochromic ink has at least partially penetrated the upper surface of the recipience layer, and after the at least a first photochromic ink has at least partially dried to form a photochromic dye containing recipience layer, applying a first polymer formulation on the photochromic dye containing recipience layer to form an overcoat layer.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 provides a schematic block diagram of a method of treating an optical surface, according to aspects of the present invention;

FIG. 1A provides an optional method step in which the first photochromic ink applied to the recipience layer further containing at least a first softening agent adapted to soften the recipience layer;

FIG. 1B provides an optional method step in which a softening agent may be applied to the surface of the recipience layer in an independent fashion with respect to the first photochromic ink;

FIG. 1C provides an optional method step in which the printing system is controlled such that in operating mode, the drops of softening agent to be applied and the photochromic ink drops of the first photochromic ink are delivered to the recipience layer surface in close proximity;

FIG. 2A provides an optional method step in which the first photochromic ink is applied in a selective manner to produce a first region within the recipience layer that is relatively rich in the first photochromic dye, with respect to a second region within the recipience layer that is relatively poor in the first photochromic dye;

FIG. 2B provides an optional method step in which the first photochromic ink is applied selectively to produce an uneven hardness in the photochromic dye containing recipience layer, whereby a second local hardness in the second region exceeds a first local hardness in the first region;

FIG. 2C provides an optional method step in which the applying of the first photochromic dye or ink may be performed using a first formulation in a first discrete step, and the applying of the at least a first softening agent may be performed using a second formulation in a second discrete step, the first formulation being different from the second formulation;

FIG. 2D provides optional steps for the schematic block diagram of FIG. 1, in which a wet hardcoat layer is applied on the exposed, dried overcoat layer;

FIG. 2E provides an optional method step in which the photochromic dye containing ink is dried to form the photochromic dye containing recipience layer;

FIG. 2F provides an optional method step in which a first surface of the ophthalmic substrate is pre-treated to form the ophthalmic surface;

FIG. 2G provides an optional method step for the schematic block diagram of FIG. 2F, in which the pre-treatment of FIG. 2F includes applying a primer to the surface of the ophthalmic substrate, wherein the primer is dried to obtain a dried primer layer;

FIG. 2H provides an optional step for any of the above-mentioned schematic block diagrams, in which the application of the photochromic dye onto the dried recipience layer is performed for at least two photochromic dye containing inks;

FIG. 3 is a schematic cross-sectional view of an optical substrate having an optical construction fixedly attached to a broad surface thereof, according to aspects of the present invention;

FIG. 4 is a schematic cross-sectional view of an ophthalmic structure, which includes an ophthalmic substrate having an ophthalmic construction fixedly attached to a broad surface of the substrate;

FIG. 5 schematically provides exemplary embodiments of a recipience layer having first regions that are relatively rich in the first photochromic dye, with respect to second regions within the recipience layer that are relatively poor in the first photochromic dye;

FIG. 6A provides a schematic cross-sectional view of an ophthalmic structure including an ophthalmic substrate having an optical or ophthalmic construction fixedly attached to a broad surface thereof, and having a selective disposition of softening agent within the recipience layer containing the photochromic ink;

FIG. 6B provides schematic plots of the local softening agent concentration and the local hardness of the recipience layer of FIG. 6A, as a function of position along the length of the ophthalmic structure;

FIG. 6C provides a schematic cross-sectional view of an ophthalmic structure including an ophthalmic substrate having an optical or ophthalmic construction fixedly attached to the inner broad surface thereof, and having a selective disposition of softening agent within the recipience layer containing the photochromic ink; and

FIG. 7 plots normalized absorbance as a function of time for four photochromic ink samples having a plasticizer concentration ranging from 0% to 5%.

### DESCRIPTION OF THE PREFERRED EMBODIMENTS

The principles and operation of the optical constructions according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Coated optical substrates often contain at least one photochromic dye. Such dyes typically change color—reversibly—in response to ultraviolet light, usually turning clear in the absence of sunlight or other source of ultraviolet light. In this photochromic transition, the photochromic dye undergoes a reversible photochemical reaction in which an absorption band in the visible part of the electromagnetic spectrum changes in strength or wavelength.

For practical use in optical coatings, the properties of the photochromic material must satisfy numerous performance criteria, conditions and constraints, a non-exhaustive list of which includes: providing a noticeable, major change in color; rate of color change (in both directions); minimal residual color; thermal stability under ambient conditions for both states of the photochromic dye; sufficient efficiency of the photochromic change with respect to the amount of light absorbed (“quantum yield”); minimal or sufficient non-overlapping of the active absorbance bands of the two states; long-term stability of the photochromic reversibility (“fatigue resistance”): photochromic materials become less reversible over time, due to photodegradation, photooxidation, and other processes; providing a suitable environment accommodating the polarity of each state, and the resultant differential in polarity; accommodating for the different—sometimes appreciably different—intrinsic kinetics with respect to the photochromic change.

There exist sundry technological challenges in producing coated optical substrates, more particularly, coated optical substrates whose coating contains a photochromic dye, and yet more particularly, coated optical substrates whose coating contains two or more photochromic dyes.

The technological challenges may also relate to various stringent performance criteria for the coated optical construction, such as the kinetics of the color change, residual color, uniformity of the color change, and the physical and chemical durability of the coated optical construction over the long term. Hard coatings surrounding the photochromic dye may appreciably impair the transition of the dye from one state to another, such that the fading kinetics of the dye with such coatings are unacceptably low.

One aspect of the present invention pertains to a method of applying or depositing a plurality of formulations to an optical substrate, some of which formulations may be applied before or after the photochromic ink formulations.

The inventors have found that applying a plurality of optical coatings to an optical substrate involves a variety of technological hurdles. Some of these relate to optical substrates, which tend to be highly smooth, and substantially non-absorbent. Optical substrates are generally transparent, and may require a high degree of transparency from the plurality of optical coatings. Moreover, the refractive index of each coating, or of all the coatings together, is constrained to be similar to that of the optical substrate.

The plurality of optical coatings must satisfy mechanical criteria such as hardness and/or scratch resistance. Each of the plurality of coatings must also be relatively inert to the other coatings in contact therewith. Moreover, since the coatings may be applied successively, at least one of the applied wet, or uncured, formulations may contact, and interact with, a previously applied coating. This may be particularly problematic in the case of successive applications of different photochromic ink formulations and of other formulations applied before or after the photochromic ink formulations.

The curing time of each coating or layer should be reasonable (at most minutes or hours), and the curing temperature should be sufficiently low so as not to damage the optical substrate, nor to damage any previously applied coatings.

The adhesion to the optical or ophthalmic substrate and resistance to peeling or cracking of the coating or coatings may also be crucial to obtaining a viable coated lens such as a coated ophthalmic lens.

Above and beyond all of the above, the inventors have found that attaining sufficient photochromic color density, while being a significant technological feature for such coated lenses, may be difficult to obtain. Moreover, attaining sufficient photochromic color density may require a thick layer of photochromic ink, which may, among other things, appreciably compromise the mechanical integrity of the coatings.

The inventors have found that poor photochromic color density may stem from various constraints in formulating the photochromic formulations. The solubility of the photochromic dye may be disadvantageously low in a wide variety of conventional solvents. In addition, the inventors have found that such low solubility may be compounded and exacerbated by the presence of a polymeric material (e.g., a resin) within the photochromic formulation. Firstly, it becomes necessary to find a solvent medium in which both the photochromic dye and the polymer have reasonably-high solubility. Secondly, the solubilization of the polymer may appreciably reduce the solubility of the photochromic dye within the solvent medium.

The inventors have discovered that it is possible to form a polymeric recipience layer on the optical surface that can receive and absorb high concentrations of photochromic dye. The photochromic ink may be applied to the top surface of this recipience layer, and the ink (typically as ink drops such as inkjetted ink drops) may penetrate the top surface and become fully immersed within the recipience layer.

This process relaxes the constraint on photochromic ink that the ink must contain relatively high concentrations of polymer, thereby allowing the concentration of photochromic dye within the photochromic ink to be appreciably increased. This, in turn, may serve to further improve the reception of the photochromic dye within the recipience layer, yielding even further improvements in the optical density provided by the photochromic dye received and absorbed within the recipience layer of the present invention.

It is well known in the art of lens coating that coating materials need to be hard in order to withstand abrasion, scratching and the like. The recipience layer of the present invention may be substantially softer than materials typically utilized for lens coatings for non-photochromic applications. This may be particularly disadvantageous, from a mechanical standpoint. However, the inventors have found that this deficiency may be somewhat mitigated by the high optical density achieved, per unit thickness of recipience layer, which may greatly reduce the overall required thickness of the polymeric layer containing the photochromic dye. The challenge remains, however, to utilize hard coatings while at the same time enabling the photochromic dye disposed in such hard coatings to exhibit sufficiently fast fading kinetics.

The inventors have discovered that a softening agent may be selectively applied to the polymeric recipience layer in the vicinity of the photochromic dye, to produce an uneven hardness in the recipience layer: the recipience layer may exhibit an appreciably lower local hardness in regions adjacent to the photochromic dye, relative to the appreciably higher local hardness exhibited in regions of the recipience layer that are not adjacent to the photochromic dye.

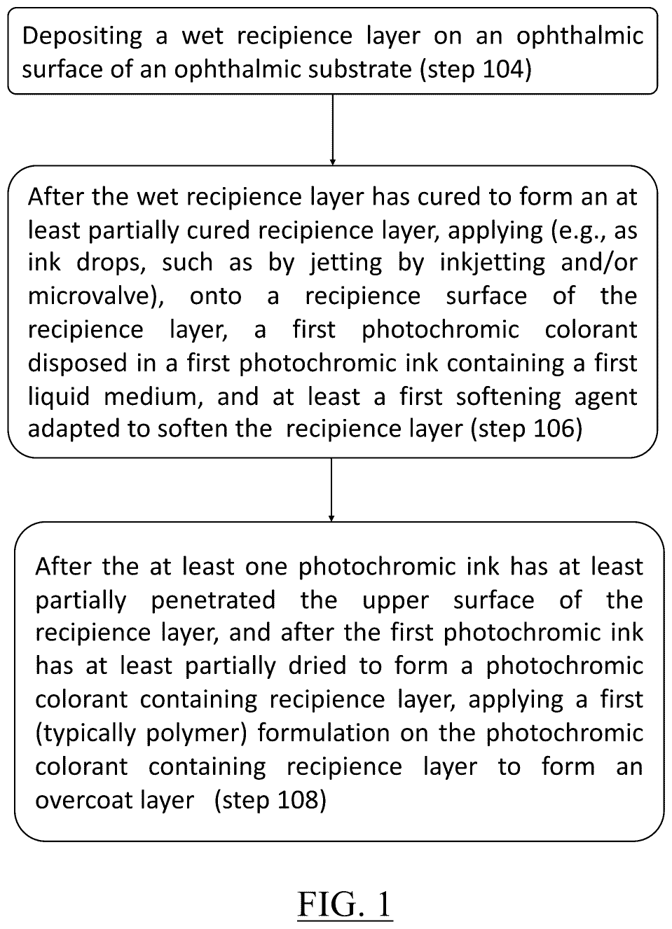

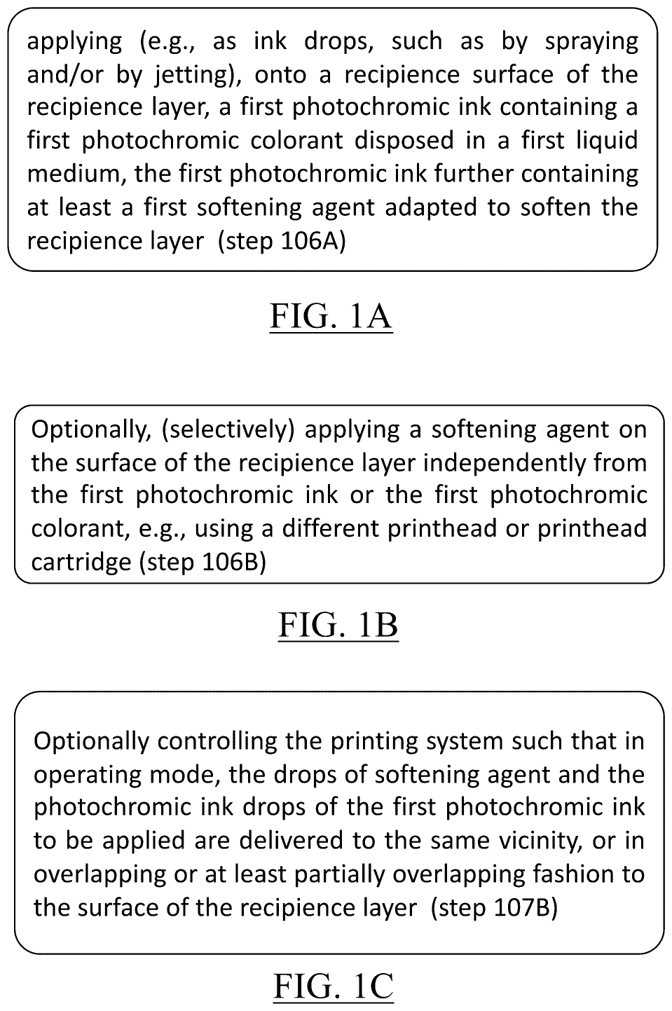

Some teachings of the present invention pertain to a method of treating an ophthalmic (or optical) surface. As schematically presented in FIG. 1, the method includes depositing a wet recipience layer on an ophthalmic surface of an ophthalmic substrate (step 104). The term “ophthalmic substrate”, as used herein, refers to a substrate that is used by the human eye to view therethrough. The ophthalmic substrate is a component of an ophthalmic device or system, or an ophthalmic component of such a device or system. Typically, the ophthalmic substrate is a lens, and the ophthalmic surface is a surface of the lens. Other applications will be appreciated by those of skill in the art, including, by way of example, a transparent helmet visor. While the lens may conceivably be a glass lens, more typically the lens is a polymeric lens, e.g., a thermoplastic polymeric lens.

More generally, the term “ophthalmic”, as used herein to modify a structure, such as “substrate”, “surface”, “construction”, “structure”, “device”, “arrangement”, and “system”, refers to the property of that structure that enables the human eye to view an object therethrough. While a coated lens is a typical example of an ophthalmic device, other applications will be appreciated by those of skill in the art, including, by way of example, a helmet having a transparent visor.

An ophthalmic construction may be an ophthalmic component of such an ophthalmic device or system.

In some embodiments, the first recipience layer is an untreated or raw recipience layer such as a wet recipience layer. The term “wet”, typically with respect to a layer such as a recipience layer, does not necessarily indicate the presence of a solvent or liquid medium, and is meant to include an uncured layer or at least partially uncured layer.

In some embodiments, the depositing of the wet recipience layer is by spin coating.

In some embodiments, the depositing of the wet recipience layer is by dip coating.

In some embodiments, the depositing of the wet recipience layer is by slit coating.

In some embodiments, the depositing of the wet recipience layer is by die coating.

In some embodiments, the depositing of the wet recipience layer is by stamp coating.

In some embodiments, the wet (e.g., uncured) recipience layer has an average thickness within a range of 1 to 120 micrometers (μm), 1.5 to 100 μm, 2 to 100 μm, 2 to 50 μm, 2 to 20 μm, 2 to 15 μm, 2 to 10 μm, 2.5 to 15 μm, 2.5 to 12 μm, 2.5 to 10 μm, 3 to 20 μm, 3 to 15 μm, 3 to 12 μm, 3 to 10 μm, 4 to 70 μm, 4 to 30 μm, 4 to 20 μm, 4 to 15 μm, 4 to 10 μm, 5 to 70 μm, 5 to 50 μm, 5 to 20 μm, 7 to 70 μm, 7 to 50 μm, 7 to 20 μm, 10 to 70 μm, 12 to 50 μm, 12 to 70 μm, 12 to 60 μm, 15 to 70 μm, 15 to 50 μm, 18 to 70 μm, 18 to 60 μm, 20 to 70 μm or 20 to 50 μm. The content of volatile solvent within the wet recipience layer may strongly affect the wet layer thickness.

The method further includes, after the wet recipience layer has dried or otherwise cured to form an at least partially cured recipience layer, applying (e.g., as ink drops, such as by jetting by inkjetting and/or microvalve), onto a recipience surface of the recipience layer, a first photochromic dye disposed in a first photochromic ink containing a first liquid medium, and at least a first softening agent adapted to soften the recipience layer (step 106).

The first photochromic ink contains a first photochromic dye disposed within a first liquid medium, and in some embodiments, a softening agent adapted to soften the recipience layer. In this case, and as provided in FIG. 1A, step 106 would include step 106A, applying (e.g., as ink drops, such as by spraying and/or by jetting), onto a recipience surface of the recipience layer, a first photochromic ink containing a first photochromic dye disposed in a first liquid medium, the first photochromic ink further containing at least a first softening agent adapted to soften the recipience layer.

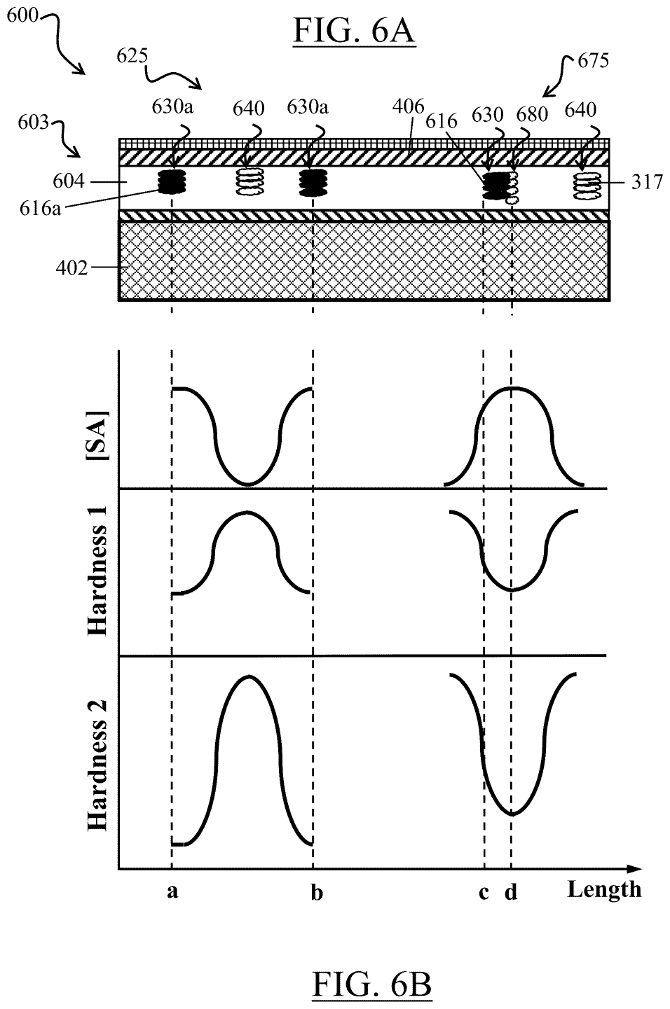

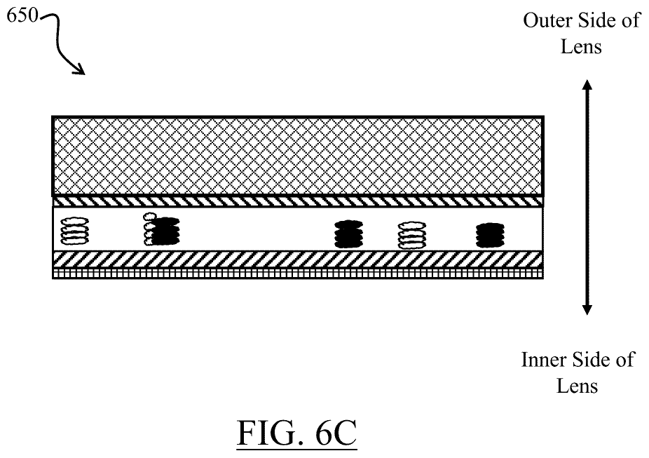

In some embodiments, additionally or alternatively, a softening agent may be (selectively) applied to the surface of the recipience layer independently from the first photochromic ink or the first photochromic dye, e.g., using a different printhead or printhead cartridge (step 106B of FIG. 1B). In this case, the printing system may be controlled such that in operating mode, the drops of softening agent to be applied and the photochromic ink drops of the first photochromic ink are delivered to the same vicinity, or in overlapping or at least partially overlapping fashion to the surface of the recipience layer (step 107B of FIG. 1C). This is described in further detail below with reference to FIG. 6.

The dry or fully cured recipience layer has a characteristic König hardness, measured in seconds. In the specification and claims, all König hardness values are measured according to ASTM D4366-95.

In some embodiments, the König hardness is at least 30 or at least 40.

In some more typical embodiments, the König hardness is at least 50, or at least 60.

In yet more typical embodiments, the König hardness is at least 70.

In some embodiments, the König hardness is at least 80.

In some embodiments, the König hardness is at least 90.

In some embodiments, the König hardness is at least 100.

In some embodiments, the König hardness is at least 110.

In some embodiments, the König hardness is at least 120.

In some embodiments, the König hardness is at most 180.

In some embodiments, the König hardness is at most 170.

In some embodiments, the König hardness is at most 160.

In some embodiments, the König hardness is at most 150.

In some embodiments, the König hardness is at most 140.

In some embodiments, the König hardness is at most 130.

In some embodiments, the König hardness is within a range of 45 to 180, 65 to 175, 70 to 175, 80 to 175, 90 to 175, 90 to 165, 100 to 175, 110 to 175, or 120 to 165.

The dry or completely cured recipience layer has a characteristic ultimate elongation, measured in percent. In the specification and claims, all ultimate elongation values are measured according to ASTM D638.

In some embodiments, the dry or completely cured recipience layer has an ultimate elongation of at least 20%, at least 30%, at least 40%, at least 50%, at least 60%, at least 80%, or at least 100%.

In some embodiments, the dry or completely cured recipience layer has an ultimate elongation of at most 475%, at most 425%, at most 400%, at most 350%, at most 325%, at most 300%, at most 275%, at most 250%, at most 225%, at most 200%, or at most 175%.

In some embodiments, the ultimate elongation is within a range of 25 to 475, 30 to 450, 40 to 425, 50 to 425, 60 to 400, 70 to 400, 70 to 350, 70 to 300, 80 to 375, 90 to 350, 90 to 300, or 100 to 350.

The dry or completely cured recipience layer has a hardness that may be characterized by pencil hardness. In the specification and claims, all pencil hardness values are measured according to ASTM D3363.

In some embodiments, the dry or completely cured recipience layer has a pencil hardness of at most 4H.

In some embodiments, the dry or completely cured recipience layer has a pencil hardness of at least 2B, at least B, at least HB, at least F, at least H, or at least 2H.

In more typical embodiments, the pencil hardness of the dried or completely cured recipience layer is within a range of 2B to 4H, 2B to 3H, 2B to 2H, B to 4H, B to 3H, B to 2H, HB to 4H, HB to 3H, HB to 2H, F to 4H, F to 3H, F to 2H, H to 4H, H to 3H, H to 2H, 2H to 4H, or 2H to 3H.

As used herein in the specification and in the claims section that follows, the term “standard pencil hardness unit” and the like refers to one degree of hardness on the 19-degree scale of graphite pencil hardness: 14B, 12B, 10B, 8B, 7B, 6B, 5B, 4B, 3B, 2B, B, HB, F, H, 2H, 3H, 4H, 5H, and 6H. By way of example: a 3H degree of hardness exceeds a 2H degree of hardness by 1 standard pencil hardness unit; a 2H degree of hardness exceeds an F degree of hardness by 2 standard pencil hardness units.

The dry or completely cured recipience layer has a hardness that may be characterized by various indentation techniques, including nanoindentation. In the specification and claims, all nanoindentation values are measured according to ASTM E384.

In some embodiments, the ophthalmic substrate or lens may be coated or pre-coated with a hardcoat, and the recipience layer may applied directly on top of this coating.

In some embodiments, a primer may first be applied to this hardcoat, prior to the application of the recipience layer, in order to enhance adhesion of the recipience layer to the substrate.

The applying (e.g., printing and/or jetting) onto a recipience surface of the recipience layer of a first (or more) photochromic dye disposed in a first photochromic ink containing a first liquid medium, and at least a first softening agent adapted to soften the recipience layer (step 106) may be performed utilizing various technologies.

In some embodiments, this applying of the photochromic dye or photochromic dye containing ink includes printing.

In some embodiments, in the applying of the photochromic dye or photochromic dye containing ink, the ink is applied onto the dried or at least partially cured recipience layer as ink drops.

In some embodiments, the applying or depositing of the ink drops is performed by printing.

In some embodiments, the depositing of the ink drops is performed according to a digital pattern.

In some embodiments, the applying of the ink drops is performed according to a pre-determined pattern such as a pre-determined digital pattern.

In some embodiments, the applying of the ink drops is performed by ink-jet printing.

In some embodiments, the applying of the ink drops is performed by at least one microvalve in a microvalve system.

In some embodiments, the applying of the ink drops is performed by spraying such as ultrasonic spraying.

In some embodiments, the applying of the ink drops is performed by printing such as silkscreen printing.

In some embodiments, the applying of the ink drops is performed by offset printing.

In some embodiments, the applying of the ink drops is performed by gravure printing.

In some embodiments, the applying of the ink drops is performed by stamp printing, such as tampon printing or pad printing.

The photochromic dye containing ink and the recipience layer may be adapted to one another, to allow the photochromic dye containing ink to at least partially penetrate the upper surface of the dried recipience layer.

In some embodiments, the ink and the recipience layer are adapted to one another, to allow the photochromic dye containing ink to at least partially penetrate the upper surface of the dried recipience layer within 10 minutes, and more typically, within 3 minutes, within 1 minute, or within 20 seconds.

In some embodiments, the ink and the recipience layer are adapted to one another, to allow the photochromic dye containing ink to at least partially penetrate the upper surface of the dried recipience layer essentially in instantaneous fashion.

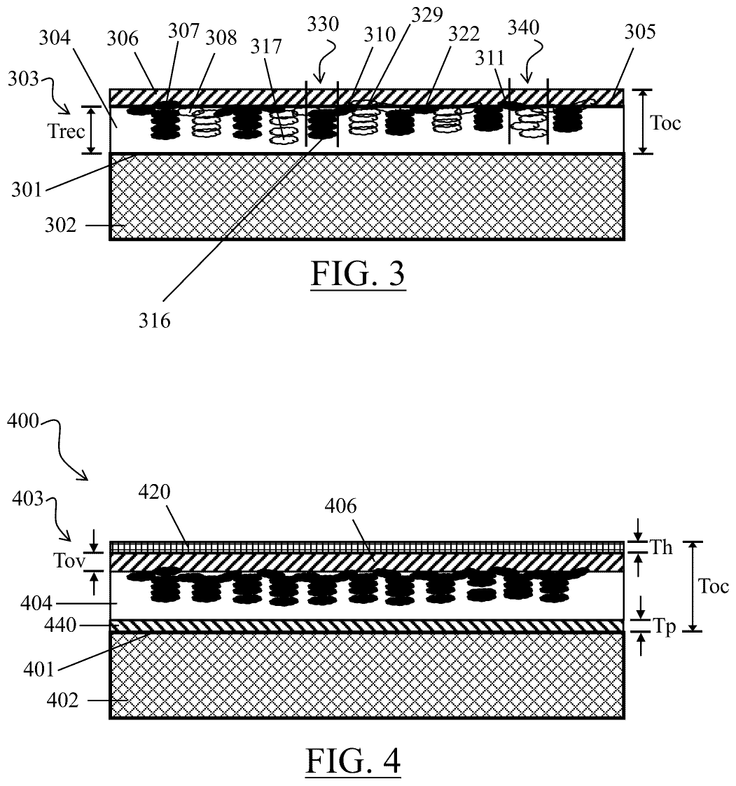

FIG. 3 is a schematic cross-sectional view of an optical substrate 302 having an optical construction 303 fixedly attached to a broad surface 301 thereof, according to aspects of the present invention. The layer of optical construction 303 that is immediately above optical substrate 302 is recipience layer 304, which has a thickness Trec. FIG. 3 schematically shows the partial penetration of an ink dot 307 with respect to the upper surface 305 of recipience layer 304.

In some embodiments, the ink and the recipience layer are adapted to one another, to allow the photochromic dye containing ink to fully penetrate the upper surface of the dried recipience layer within 10 minutes, and more typically, within 3 minutes, within 1 minute, or within 20 seconds. Typically, the ink solvent and recipience layer are selected to have mutual affinity, e.g., based on the Hansen parameters, of which the polarity component may be the most important.

FIG. 3 schematically shows the complete penetration of ink drops such as ink dot 317 with respect to the upper surface 305 of recipience layer 304. FIG. 3 further shows a first set of photochromic ink dots (photochromic ink #1) such as ink dot 316, and a second set of photochromic ink dots (photochromic ink #2) such as ink dot 317.

In some embodiments, photochromic ink (or dye) #1 is deposited onto recipience layer 304 based on a digital or pre-determined pattern or array. Similarly, photochromic ink (or dye) #2 may be deposited onto recipience layer 304 based on a digital or pre-determined pattern or array.

In some embodiments, the photochromic ink or dye may be deposited in drop-on-drop fashion onto recipience layer 304. Such an operation may produce “columns” of ink (or dye) dots such as ink (or dye) column 330 of photochromic ink #1 and ink (or dye) column 340 of photochromic ink #2. It is noted that, as schematically shown in column 340, the ink drops may not be deposited exactly one on top of the other, such that the width of the column may be appreciably larger than the width of the individual dots.

Ink columns (or “pillars”) such as ink column 330 and ink column 340 may be advantageous in that they maintain separation between different photochromic dyes having different properties (e.g., activation and fading kinetics). Such ink columns advantageously allow high photochromic dye densities per unit (viewing) area. Such ink columns yet further advantageously allow high photochromic dye densities per unit area within a single layer of the ophthalmic medium (in this case, the “recipience layer”). All these advantages notwithstanding, the inventors have discovered that such “pixelization” of the different photochromic dyes using dot-on-dot jetting may disadvantageously affect the optical or ophthalmic properties of the optical construction. For example, such ink columns may produce a “slitting” type of effect, which may be deleterious for many ophthalmic products and applications.

The inventors have further discovered that by applying a large number of dot-on-dots, a portion of the dots do not serve to thicken the columns, rather, they “flood” the recipience layer in between the columns, for example, ink dot 322 of photochromic ink #1 and ink dot 308 of photochromic ink #2. In some cases, the ink drops may fail to fully penetrate the upper surface 305 of the recipience layer, as ink dots 310, 311 and 329 schematically demonstrate. The inventors have surprisingly discovered that in applying such a large number of drop-on-drops, the optical or ophthalmic properties of the optical construction may actually be improved. The advantages of the pixelization may remain substantially intact, while the deleterious “slitting” effect may be appreciably reduced or mitigated.

Thus, in some embodiments, at least 4 ink drops or at least 6 ink drops are applied in a drop-on-drop fashion. More typically, at least 8, at least 10, at least 12, at least 15, at least 18, at least 20, at least 22, at least 25, at least 28, at least 30, at least 32, or at least 35, are applied in a drop-on-drop fashion. The number of ink drops applied in such drop-on-drop fashion may be at most 100, and more typically, at most 80, at most 70, at most 60, at most 50, or at most 45.

The inventors have found that photochromic dye disposed above upper surface 305 of the recipience layer may be deleterious to the optical or ophthalmic properties of the optical construction. However, the inventors have further discovered that by applying an overcoat layer 306 on top of recipience layer 404, such exposed photochromic dye may be covered, such that such photochromic dye actually contributes to the quality of the optical construction.

Thus, with reference now to FIG. 1 as well, the inventive method may further include, after the at least one photochromic ink has at least partially penetrated the upper surface of the recipience layer, and after the first photochromic ink has at least partially dried to form a photochromic dye containing recipience layer, applying a first (typically polymer) formulation on the photochromic dye containing recipience layer to form an overcoat layer such as a first overcoat layer (step 108).

In some embodiments, the drying may be completely passive.

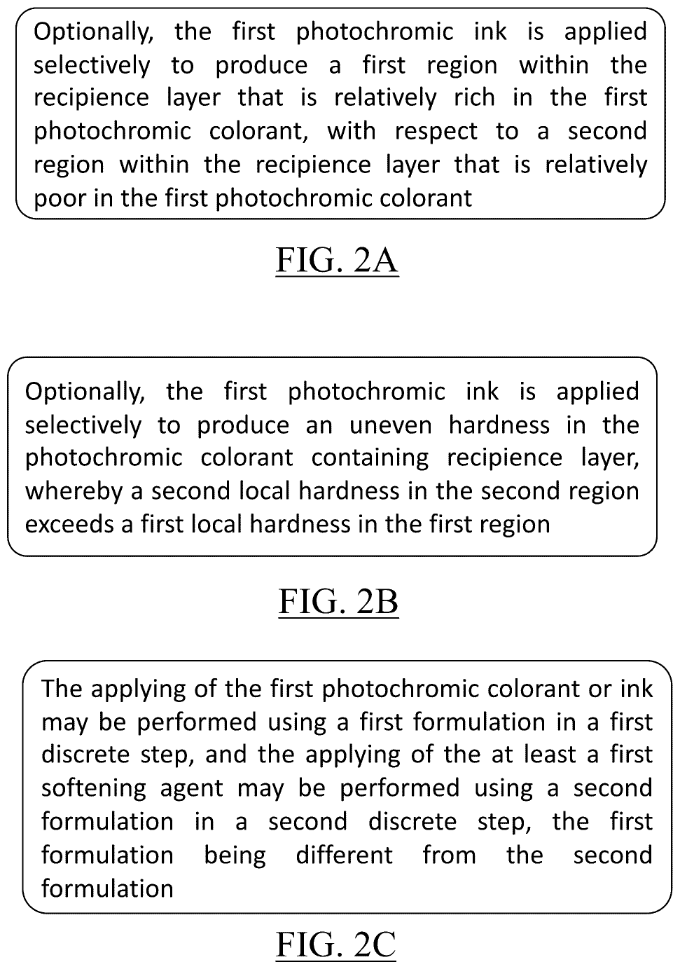

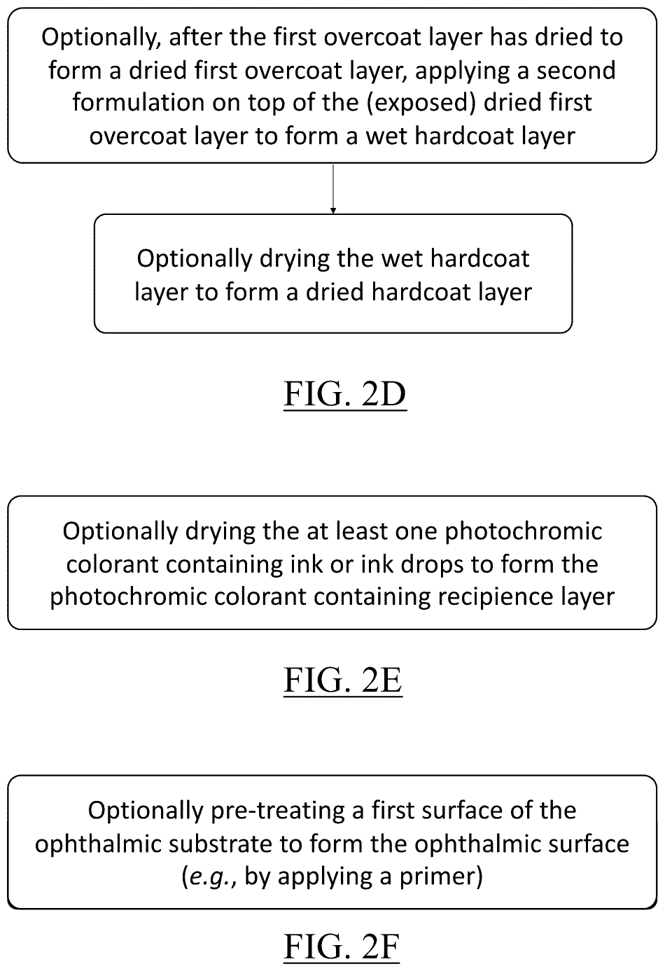

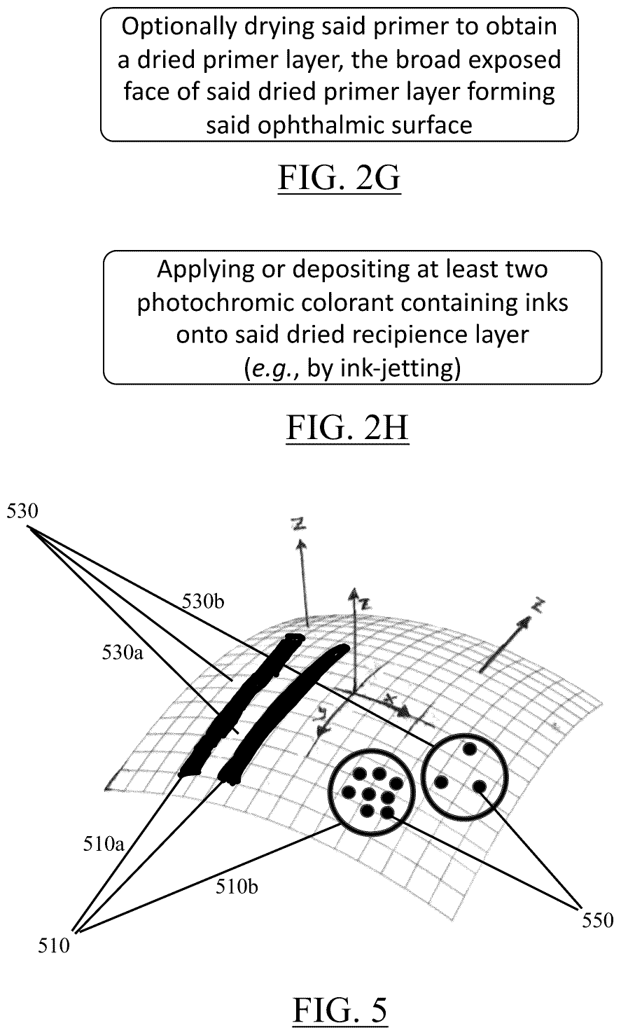

In some embodiments, and as shown in FIG. 2E, the inventive method may further include drying the at least one photochromic dye containing ink or ink drops to form the photochromic dye containing recipience layer.

In some embodiments, the photochromic dye containing recipience layer, after complete drying, has a thickness or an average thickness within the range of 0.6 micrometers (μm) to 80 μm or 1 μm to 80 μm, and more typically, within a range of 1.5 to 70 μm, 1.5 to 30 μm, 1.5 to 15 μm, 1.5 to 10 μm, 1.5 to 8 μm, 1.5 to 6 μm, 2 to 70 μm, 2 to 50 μm, 2 to 30 μm, 2 to 15 μm, 2 to 10 μm, 2 to 8 μm, 2 to 6 μm, 2.5 to 30 μm, 2.5 to 20 μm, 2.5 to 12 μm, 2.5 to 8 μm, 2.5 to 6 μm, 3 to 70 μm, 3 to 50 μm, 4 to 70 μm, 4 to 50 μm, 5 to 70 μm, 5 to 50 μm, 5 to 40 μm, 7 to 70 μm, 7 to 50 μm, 7 to 40 μm, 7 to 30 μm, 10 to 70 μm, 10 to 50 μm, 10 to 30 μm, 12 to 70 μm, 12 to 50 μm, 12 to 40 μm, 12 to 30 μm, or 15 to 50 μm.

In some embodiments, the applying or depositing of the first polymer formulation is performed after the ink drops have fully penetrated the upper surface of the dried recipience layer.

The first overcoat layer may be disposed above, and fixedly attached to, the polymeric, photochromic dye containing recipience layer.

In some embodiments, the first overcoat layer, as a wet layer, has a thickness or an average thickness within a range of 1.5 to 70 μm or within a range of 2.5 to 70 μm, and more typically, within a range of 4 to 70 μm, 5 to 70 μm, 5 to 50 μm, 5 to 40 μm, 5 to 30 μm, 7 to 50 μm, or 7 to 30 μm.

In some embodiments, the first overcoat layer, as a dry layer, has a thickness or an average thickness within a range of 1 to 50 μm or within a range of 1 to 30 μm, and more typically, within a range of 1 to 20 μm, 1 to 15 μm, 1 to 10 μm, 1 to 7 μm, 1.5 to 15 μm, 1.5 to 10 μm, 1.5 to 7 μm, 1.5 to 5 μm, 2 to 15 μm, 2 to 7 μm, or 2 to 5 μm.

In some embodiments, the first overcoat layer is a thermoplastic polymer.

In some embodiments, the first overcoat layer is a thermoset polymer.

In some embodiments, the first overcoat formulation is a polymer emulsion.

In some embodiments, the first overcoat formulation is a polymer dispersion.

In some embodiments, the first overcoat formulation includes an acrylic polymer.

In some embodiments, the first overcoat formulation includes polyurethane.

In some embodiments, the material of the dry or completely cured overcoat layer has a König hardness of at least 80 (seconds). More typically, this König hardness is within a range of 80 to 180, 80 to 160, 90 to 180, 100 to 160, 100 to 150, 100 to 140, 110 to 180, 110 to 160, or 110 to 150.

With reference again to the figures (FIG. 2A), and as shown schematically in FIG. 5, optionally the first photochromic ink may be applied in a selective manner to produce a first region 510 within the recipience layer that is relatively rich in the first photochromic dye 550, with respect to a second region 530 within the recipience layer that is relatively poor in the first photochromic dye 550 (or devoid thereof). Photochromic dye rich first region 510 may contain an area that is fully covered by the first photochromic ink or dye, such as first region 510a, and/or an area that is partially covered by the first photochromic ink or dye, such as first region 510b. Similarly, photochromic dye poor second region 530 may contain an area that is substantially devoid of the first photochromic ink or dye, such as second region 530a, and/or an area that is partially covered by the first photochromic ink or dye, such as second region 530b.

It will be appreciated that second region 530, while relatively poor in first photochromic ink or dye, may be relatively rich with respect to another photochromic ink or dye.

As used herein in the specification and in the claims section that follows, the selectivity in applying the ink (e.g., the first photochromic ink) is defined with respect to the normal direction (z) to the x-y surface of the ophthalmic substrate. This too is schematically illustrated in FIG. 5. It will be appreciated that the x-y surface may be a curved surface, and that the normal direction (z) may vary from point to point on the x-y surface.

With reference to FIG. 2B, optionally, the first photochromic ink is applied selectively to produce an uneven hardness in the photochromic dye containing recipience layer, whereby a second local hardness in the second region exceeds a first local hardness in the first region. This is shown schematically in FIG. 6, which will be described in further depth hereinbelow.

With reference now to FIG. 2C, the applying of the first photochromic dye or ink may be performed using a first formulation in a first discrete step, and the applying of the at least a first softening agent may be performed using a second formulation in a second discrete step, the first formulation being different or chemically different from the second formulation.

FIG. 2D provides optional blocks for the schematic block diagram of FIG. 1, in which a wet hardcoat layer is applied on the exposed, dried overcoat layer. An exemplary optical construction obtained is shown schematically in FIG. 4. FIG. 2F provides an optional block for any of the above-mentioned schematic block diagrams, in which a first or upper surface of the ophthalmic substrate is pre-treated to form the ophthalmic surface.

In some embodiments, the pre-treatment of the lens surface includes a surface energy treatment.

In some embodiments, the surface energy treatment of the lens surface includes a corona treatment.

In some embodiments, the surface energy treatment of the lens surface includes a plasma treatment.

In some embodiments, the surface energy treatment of the lens surface includes an electron beam treatment.

In some embodiments, the surface energy treatment of the lens surface includes an electrical discharge treatment.

In some embodiments, the pre-treatment of the lens surface includes an etching treatment.

In some embodiments, the etching treatment includes laser etching.

In some embodiments, the etching treatment includes chemical etching.

FIG. 2G provides an optional block for the schematic block diagram of FIG. 2F, in which the pre-treatment of FIG. 2F includes applying a primer (or wet primer layer) to the surface of the ophthalmic substrate (lens surface). This primer is subsequently dried, or allowed to dry, to obtain a dried primer layer. An exemplary optical construction obtained is shown schematically in FIG. 4, which will be described in further detail hereinbelow.

In some embodiments, the primer pre-treatment is directed to facilitate wetting of the wet recipience layer with respect to the lens surface.

In some embodiments, the primer pre-treatment is directed to facilitate adherence of the wet recipience layer with respect to the lens surface.

In some embodiments, the primer is a polymeric primer.

In some embodiments, the polymeric primer is in the form of a waterborne emulsion (e.g., an acrylic emulsion).

In some embodiments, the polymeric primer is in the form of a solution (e.g., a polyurethane resin solution).

In some embodiments, the wet primer layer has at least one of a thickness and an average thickness within a range of 0.3 to 5 μm or within a range of 0.3 to 3 μm, and more typically, within a range of 0.3 to 2.5 μm, 0.3 to 2 μm, 0.4 to 2 μm, 0.4 to 1.5 μm, 0.5 to 2 μm, 0.5 to 1.8 μm, 0.5 to 1.5 μm, or 0.5 to 1.2 μm.

In some embodiments, the dried or dry primer layer has at least one of a thickness and an average thickness within a range of 0.3 to 4 μm or within a range of 0.3 to 2.5 μm, and more typically, within a range of 0.3 to 2 μm, 0.3 to 1.5 μm, 0.4 to 2 μm, 0.4 to 1.5 μm, 0.5 to 2 μm, 0.5 to 1.8 μm, 0.5 to 1.5 μm, or 0.5 to 1.2 μm.

FIG. 2H provides an optional block for any of the above-mentioned schematic block diagrams, in which the application of the photochromic dye onto the dried recipience layer (step 106) is performed for at least two photochromic dye containing inks.

FIG. 4 is a schematic cross-sectional view of an optical or ophthalmic device, component or structure 400, which includes an optical or ophthalmic substrate 402 having an optical or ophthalmic construction 403 fixedly attached to a broad surface 401 of the optical or ophthalmic substrate 402. Construction 403 further includes a primer layer 440 disposed between broad surface 401 and photochromic-dye-containing recipience layer 404. The thickness of primer layer 440 is designated as Tp. Above recipience layer 404 may be disposed an overcoat layer 406, substantially as described hereinabove. The thickness of overcoat layer 406 is designated as Tov. Above overcoat layer 406 may be disposed a hardcoat layer 420, according to further independent features of the present invention. The thickness of hardcoat layer 420 is designated as Th. The entire thickness of optical construction 403 (and 303 in FIG. 3) is designated as Toc.

In some embodiments, the hardcoat layer has at least one of a wet thickness and an average wet thickness within a range of 1 to 6 μm or within a range of 1 to 5 μm, and more typically, within a range of 1 to 4.5 μm, 1 to 4 μm, 1 to 3.5 μm, 1.2 to 3.5 μm, 1.2 to 3 μm, 1.5 to 4.5 μm, 1.5 to 4 μm, 1.5 to 3.5 μm, or 1.5 to 3 μm.

In some embodiments, the dry or cured hardcoat layer has at least one of a thickness Th and an average thickness Th-a within a range of 0.8 to 5.5 μm or within a range of 0.8 to 5 μm, and more typically, within a range of 0.8 to 4.5 μm, 0.8 to 4 μm, 0.8 to 3.5 μm, 1 to 3.5 μm, 0.8 to 3 μm, 1 to 3 μm, 1.2 to 4.5 μm, 1.2 to 4 μm, 1.2 to 3.5 μm, or 1.2 to 3 μm. With regard to the entire thickness Toc of optical constructions 303 and 403, in some embodiments, the dry (cured) optical construction has an average thickness within the range of 5 to 150 μm, 5 to 100 μm, 5 to 70 μm, 5 to 50 μm, 5 to 45 μm, 5 to 35 μm, 5 to 25 μm, 5 to 20 μm, 7 to 70 μm, 7 to 50 μm, 7 to 45 μm, 7 to 35 μm, 7 to 25 μm, 7 to 20 μm, 10 to 150 μm, or 5 to 120 μm, and more typically, within a range of 7 to 100 μm, 10 to 80 μm, 10 to 70 μm, 10 to 60 μm, 12 to 70 μm, 15 to 70 μm, 15 to 60 μm, or 15 to 50 μm.

FIG. 6A provides a schematic cross-sectional view of an optical or ophthalmic device, component or structure 600 including an optical or ophthalmic substrate 402 having an optical or ophthalmic construction 603 fixedly attached to a broad surface thereof, in an arrangement similar to that of FIG. 4. Furthermore, in a photochromic ink arrangement similar to that of FIG. 3, FIG. 6A provides a first set of photochromic ink dots (photochromic ink #1) such as ink dots 616 and 616A, and a second set of photochromic ink dots (photochromic ink #2) such as ink dot 317. Structure 600 has a selective disposition of softening agent within the recipience layer containing the photochromic ink.

As described above in greater detail, the photochromic ink or dye may be deposited in drop-on-drop fashion onto the recipience layer, forming, after curing, “columns” of ink (or dye) dots such as ink residue (or dye) columns 630, 330a of photochromic ink #1 and ink residue (or dye) column 640 of photochromic ink #2.

Typically, the drop-on-drop overlap may be at least 20% or at least 40%, and more typically, at least 60% or at least 80%, based on the overlap of the upper drop with respect to the lower drop. Typically, at least 10% or at least 30%, and more typically, at least 50% or at least 80% of the drops are in such a “drop-on-drop” configuration. Such a “drop-on-drop” configuration may reflect the actual positioning of the drops or the programmed positioning of the drops, e.g., a digital pattern or pre-determined pattern utilized by the printer controller.

In embodiments in which the first set of photochromic ink dots contains a softening agent (e.g., a plasticizer or a polymeric softening agent), the photochromic ink dots are labeled 616a, the corresponding photochromic ink residue (or dye) columns containing such dots 616a of photochromic ink #1 are labeled 630a, and the photochromic arrangement as a whole is labeled 625.

In embodiments in which softening agent is separately applied (i.e., with respect to the first photochromic ink) as drops, and the first set of photochromic ink dots do not contain softening agent (or a reduced amount thereof), the photochromic ink dots containing the first photochromic dye are labeled 616; the corresponding photochromic ink residue (or dye) columns containing such dots 616 of photochromic ink #1 are labeled 630; and the photochromic arrangement as a whole is labeled 675. The softening agent dots 680, as shown in exemplary fashion, are disposed largely adjacent to photochromic ink dots 616 of ink column 630, with some congruency or overlapping in the z direction. It will be appreciated that softening agent dots 680 may fully overlap or partially overlap photochromic ink dots 616, all of the above being considered a “dot-on-dot” configuration. Typically, the overlap may be at least 20% or at least 40%, and more typically, at least 60% or at least 80%, based on the overlap of the upper dot with respect to the lower dot. Typically, at least 10% or at least 30%, and more typically, at least 50% or at least 80% of the dots are in such a “dot-on-dot” configuration. In this context, a dot is a dried or fixated drop. While such overlapping appears to be advantageous, in some embodiments, softening agent dots 680 may not overlap photochromic ink dots 616, but may be disposed in close proximity to dots 616, e.g., within 10 μm, within 5 μm, or within 2 μm, so as to selectively soften the recipience layer 604 in the region of photochromic ink dots 616.

In some embodiments, the broad surface to which optical or ophthalmic construction 603 is fixedly attached is the outer surface (i.e., the outwardly facing surface) of the lens, distal to the eye of the viewer/user.

In some embodiments, and as described hereinbelow with respect to FIG. 6C, the broad surface to which optical or ophthalmic construction 603 is fixedly attached is the inner surface (i.e., the inwardly facing surface) of the lens, proximal to the eye of the viewer/user.

FIG. 6B provides schematic plots of the local softening agent concentration and the local hardness of the recipience layer 604 of FIG. 6A, as a function of position along the length of optical or ophthalmic structure 600.

With reference now to arrangement 625, in which the softening agent is disposed within the first photochromic ink, such that photochromic ink residue (or dye) columns 630A of photochromic ink #1, the concentration of softening agent [SA] is at a maximum at the center of columns 630A. Ink residue (or dye) column 640 of photochromic ink #2 is devoid of the softening agent, or contains a reduced concentration thereof, such that the concentration of softening agent [SA] is at a minimum at the center of column 640 within arrangement 625.

Consequently, the hardness of recipience layer 604 attains a maximum at the center of column 640, while attaining a minimum hardness in the vicinity of the photochromic ink dots 616a, e.g., within columns 630a. This may appreciably improve the overall transition kinetics (especially the fading time) of the first photochromic dye, with respect to the first photochromic dye when disposed in the identical recipience layer, but devoid of the softening agent.

The concentration of the selectively disposed softening agent as well as the efficacy of the softening agent may both contribute to the improvement in the overall transition kinetics. This is schematically illustrated by the Hardness 2 graph in FIG. 6B, in which the hardness is significantly reduced at the center of columns 630A, with respect to that attained in the corresponding Hardness 1 graph.

With reference now to exemplary arrangement 675, in which the softening agent is applied in drops that are distinct from the drops of the first photochromic ink, the concentration of softening agent [SA] achieves a maximum near the center of softening agent dots 680. Since dots 680 are disposed in close proximity to photochromic ink dots 616 of ink column 630, the local concentration of softening agent is high in the region of ink dots 616, and the corresponding local hardness of the recipience layer in that location is low.

FIG. 6C provides a schematic cross-sectional view of an optical or ophthalmic device, component or structure 650 including an ophthalmic substrate having an optical or ophthalmic construction fixedly attached to the inner broad surface of the ophthalmic substrate, and having a selective disposition of softening agent within the recipience layer containing the photochromic ink. It will be appreciated that the optical or ophthalmic construction may be identical or substantially identical to the exemplary optical or ophthalmic construction of FIG. 6A, or to the exemplary optical or ophthalmic construction of FIG. 3 or FIG. 4.

In some embodiments, the inner broad surface of the lens is concave.

In some embodiments, the inner broad surface of the lens is convex.

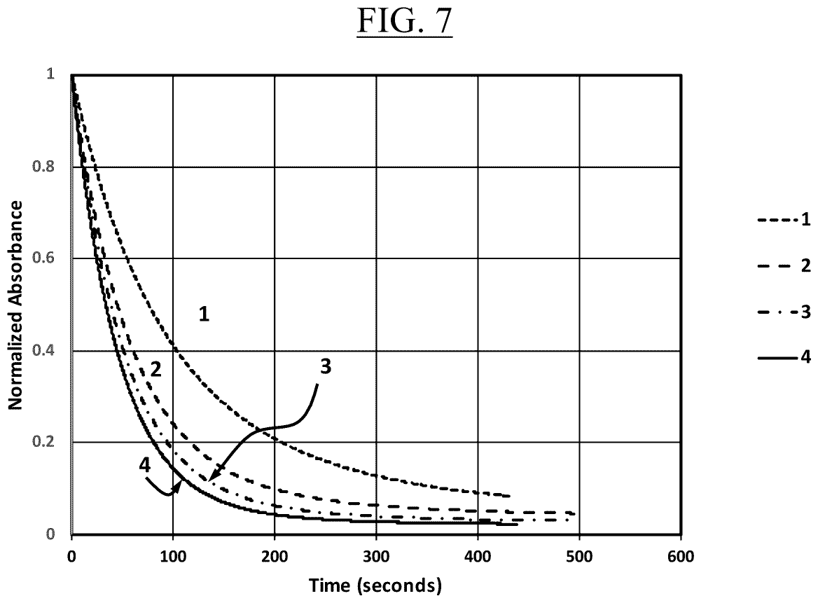

FIG. 7 plots normalized absorbance as a function of time for four photochromic ink samples having a plasticizer concentration ranging from 0% to 5%: Sample 1 has 0% plasticizer, Sample 2 has 1% plasticizer, Sample 3 has 2.5% plasticizer, and Sample 4 has 5% plasticizer. It may be seen that for any given time, the normalized absorbance is reduced with increasing plasticizer concentration.

### EXAMPLES

Reference is now made to the following examples, which together with the above description, illustrate the invention in a non-limiting fashion.

### Materials

### Photochromic Dyes (Photochromic Dyestuffs in Powder Form, all Provided by James Robinson Specialty Ingredients Ltd.):

Reversacol Amazon Green
Reversacol Midnight Gray
Reversacol Leather Brown
Reversacol Corn Yellow
Reversacol Ocean Blue

### Coalescence Solvents for Ink Carrier and Recipience Layer Formulations

Dowanol™ PMA Glycol Ether (Propylene glycol monomethyl ether acetate, or PMA);
Eastman™ DB Acetate (2-(2-butoxyethoxy) ethyl acetate, or DBA);
Dowanol™ TPM Glycol Ether (Tri-propylene glycol monomethyl ether, or TPM) (Dow);
Methyl Ethyl Ketone (2-Butanone or MEK) (Shell Chemicals);
Butyl CELLOSOLVE™ glycol ether (Ethylene glycol mono butyl ether or EB);
Dowanol™ PM Glycol Ether (Propylene glycol mono methyl ether or PM)
Hexyl CELLOSOLVE™ Solvent (Diethylene glycol mono butyl ether or n-hexylglycol)
Dowanol™ DPnP glycol ether (Dipropylene Glycol n-Propyl Ether or DPnP)
Augeo® SL 191 racemic mixture (+/−)-2,2-dimethyl-4-hydroxymethyl-1,3-dioxolane
Dowanol™ DPM glycol ether (dipropylene glycol monomethyl ether, DPM)

### Coating Materials for Recipience Layer Formulations:

### PUD-Water Based

Alberdingk® U 9150—aqueous aliphatic polyester polycarbonate-polyurethane dispersion (TPU) (Alberdingk Boley)
Alberdingk® U 6150—solvent free aliphatic polycarbonate polyurethane dispersion
Alberdingk® U 9800—solvent-free, aliphatic polyester polyurethane dispersion
Alberdingk® UC 90—aqueous, anionic, low viscous, solvent-free, self-crosslinking dispersion of copolymer based on an aliphatic polyester polyurethane and a polyacrylate
Alberdingk® UC 9900—aqueous, anionic, solvent-free dispersion of an aliphatic polyester-polyurethane
Alberdingk® U 6100—aqueous, colloidal, anionic, low viscous dispersion of an aliphatic polyester-polyurethane without free isocyanate groups
Alberdingk® CUR 991—aqueous, solvent-free, low viscous, anionic polyurethane dispersion without free isocyanate groups
Kamthane K-1492—air dry, water-borne urethane dispersion having an aliphatic backbone, 3H pencil hardness (Kamsons Polymers PVT. LTD.)
Lubrijet™ N240—Waterborne acrylic colloidal dispersion polymer for inkjet printing (Lubrizol)
Alberdingk® APU 10610—Solvent-free, self-crosslinking, aliphatic polyester polyurethane, acrylic hybrid dispersion (Alberdingk Boley)
CrystalCoat® PR 670—polyurethane water-based primer solution, 1.50 refractive index (SDC)
Alberdingk® AC 3797

### Acrylic Polymer Emulsions

JONCRYL® 2136-A—waterborne acrylic emulsion
JONCRYL® 2121—waterborne acrylic emulsion

### Thermoplastic Soluble Polymers

Mowital® B 16 H (Kuraray)—polyvinyl butyral (PVB); 18-21% polyvinyl alcohol (hydroxyl groups in terms of polyvinyl alcohol), 1-4% polyvinyl acetate (acetyl groups in terms of polyvinyl acetate)
Mowital® B 30 HH (Kuraray)—polyvinyl butyral (PVB); 11-14% polyvinyl alcohol (hydroxyl groups in terms of polyvinyl alcohol), 1-4% polyvinyl acetate (acetyl groups in terms of polyvinyl acetate)
SETALUX® 2127 XX-60—thermoplastic acrylic resin dissolved in xylene (Allnex)

### Thermoset Resins

### UV Curable Acrylic Oligomers

BR-344—difunctional, aliphatic polyether urethane acrylate oligomer (DYMAX)
BR-374—difunctional, aliphatic polyether urethane acrylate oligomer (DYMAX)
BR-345—difunctional polyether urethane acrylate (DYMAX)
BR-990—aliphatic polyether urethane triacrylate (DYMAX)

### Properties of Various Recipience Layer Coating Materials:

| | König | |
|---|---|---|
| | Hardness | Ultimate |
| | (sec) (ASTM | Elongation % |
| Polymer¹ | D 4366 - 95) | (ASTM D638) |
| Alberdingk ® APU 10610 | 60 | 450 |
| Alberdingk ® U 9150 | 100 | 100 |
| Alberdingk ® U 6100VP | 50 | 300 |
| Alberdingk ® U 6150 | 60 | 200 |
| Alberdingk ® U 9800 | 100 | 250 |
| Alberdingk ® UC 90 | 130 | |
| Alberdingk ® U 9900 | 160 | |
| Alberdingk ® CUR 991 | 85 | 120 |
| Kamthane K-1492 | 160 | 200 |
| Alberdingk ® AC 3797 | 130 | |
| Lubrijet ™ N240 | 50 | 400 |
| JONCRYL ® 2136-A | 50 | 300 |
| JONCRYL ® 2121 | 80 | 400 |
| SETALUX ® 2127 XX-60 | 50 | 400 |
| BR-344 | 120 | 190 |
| BR-374 | 80 | 290 |
| BR-345 | 100 | 290 |
| BR-990 | 200 | 65 |

¹All of the above-provided polymers have a haze measurement of less than 1% and a transmittance of over 90% as determined by the ASTM 1003 haze and luminous transmittance tests.

### Softening Agents

### Polymeric Softening Agents

Pearlcoat™ DIPP 119—Aromatic polycaprolactone copolyester-based thermoplastic polyurethane (TPU) (Lubrizol)
Pearlbond™ 360—Polyether based thermoplastic polyurethane (TPU) (Lubrizol)
Laropal® A-81—Aldehyde resin, condensed products from urea and aliphatic aldehydes (BASF)
Versamid® PUR 1010—Thermoplastic aliphatic polyurethane resin solution in an alcohol/acetate solution (BASF)
Laroflex® HS-9000—High molecular weight polyester resin solution in n-propanol (BASF).

### Plasticizers

Emoltene™ 3GO (Perstorp)—Triethylenglycol-mono-2-ethyl-hexanoate
Pevalen (Perstorp)—pentaerythritol tetra valerate (PETV)
Jayflex™ DIDP—diisodecyl phthalate—(Exxon Mobile)
Jayflex™ L9TM—tri-nonyl trimellitate (Exxon Mobile)
Jayflex™ MB 10—iso-decyl benzoate (Exxon Mobile)
DEHP—di-2-ethylhexyl phthalate (Arkema)
DEHTP—di-2-ethylhexyl terephthalate (Arkema)
Palatinol N—diisononyl phthalate (BASF)
Palatinol 10-P—di-2-propylheptyl phthalate (BASF)
Paraplex® A-8000—low molecular weight polyester adipate (Hallstar)
Paraplex® A-8200—medium molecular weight polyester adipate (Hallstar)

### Ink and Recipience Layer Formulation Additives

BYK® 3760, Polyether-modified polydimethylsiloxane (BYK, Germany)—Silicone-containing surface additive for solvent-borne, aqueous and UV systems, reduces surface tension and increases surface slip
BYK® 333, Wetting agent, Silicone-containing surface additive for solvent-free, solvent-borne and aqueous coating systems; strong surface tension reducer
BYK® 358, Leveling agent, Surface additive on polyacrylate-basis for solvent-borne and solvent-free coating and thermoset systems to improve leveling
BYK® 346 wetting additive
BYK® 044 defoamer
BYK® 024 defoamer
EFKA® FL 3277 Leveling agent, fluorocarbon-modified polyacrylate
EFKA® SL 3035 Leveling agent, organically modified polysiloxane that may be suitable for water and solvent based coatings
EFKA® SL 3200 Leveling agent, silicone-based solvent-free slip and leveling agent; suitable for aqueous, solvent-based and UV formulations
EFKA® FL 3778 Leveling agent, acrylic copolymer.

### Additives for UV Thermoset Polymers

ADDITOL® TPO (Diphenyl(2,4,6-trimethylbenzoyl) phosphine oxide, CAS #75980-60-8)—radical photoinitiator for use alone or in combination with other photoinitiators (Allnex)
SR484 octyldecyl acrylate, (CAS #4813-57-4) monofunctional acrylate monomer with hydrophobic backbone (Arkema)
HEMA, 2-hydroxyethyl acrylate, CAS #818-61-1 (Merck)
IBOA, Acrylic acid isobornyl ester isobornyl acrylate CAS #5888-33-5 (Merck)

### Primers and Overcoats

### Acrylic Polymer Emulsions:

Joncryl® 1532—waterborne acrylic emulsion offering excellent adhesion to a wide variety of substrates including plastics (BASF); Primer
Joncryl® 1534—waterborne acrylic emulsion offering excellent adhesion to a wide variety of substrates including plastics (BASF); Primer
Joncryl® 2110—waterborne acrylic emulsion primer, styrene acrylate copolymer (BASF); Primer
Joncryl® 9530-A—waterborne acrylic emulsion self-crosslinking polymer designed for use in topcoats and primers; Overcoat
Joncryl® 617-A—waterborne acrylic polymer emulsion film forming overprint varnish formulations (BASF); Overcoat
SETALUX® 17-7202—acetoacetate functional acrylic resin combined with a ketimine resin (SETALUX® 10-1440) for primer; Overcoat
SETALUX® 17-1246—a fast-dry thermoplastic acrylic resin solution providing an excellent balance of hardness, adhesion and film toughness together with clarity and transparency; Overcoat

### PU Polymer Emulsions:

ALBERDINGK® APU 10600 self-crosslinking acrylic, PES/PC-polyurethane hybrid dispersion (Alberdingk Boley); Overcoat
Bondthane™ UD-620—self-crosslinking polyurethane is ideally suited for hard, clear or pigmented coatings for rigid plastics (BPI); Overcoat
CrystalCoat® PR 670—water-based emulsion (SDC); Primer
Hi-Gard HP 1500—thermal cured coating for hard coatings (PPG); Primer

### Resin Solvent Based Solutions:

Versamid® PUR 1010—Primer
Laroflex® HS-9000—Primer.

### Hardcoat Layer:

CrystalCoat® TC-3000—polysiloxane-based tintable abrasion resistant hardcoat (SDC); refractive index of 1.49
CrystalCoat® MP-1154D—polysiloxane-based abrasion resistant hardcoat (SDC); refractive index of 1.49
CrystalCoat® MP-2020B—polysiloxane-based, highly cross-linkable, abrasion resistant hardcoat (SDC); refractive index of 1.49
NANOMYTE® SR-100—Polysiloxane-based 2-component liquid coating (NEI) providing abrasion and scratch resistance to plastic substrates
NANOMYTE® SR-100RT Polysiloxane-based single component liquid coating (NEI) providing abrasion and scratch resistance to plastic substrates.

### Equipment

### Coating Equipment

Printer: Dimatix Materials Printer DMP-2831 equipped with a 10 pL Dimatix Materials Cartridge (Fujifilm Dimatix™ Inc)
Spin coater: MUTECH μCoater (Mutech Microsystems SAS)
UV LED Curing System: FJ100 Gen 2, 395 nm, 12 W/cm² (Phoseon Technology)
Thermal Curing System: Venticell ECO Forced air oven (MMM)
Surface Activation: Corona Treatment Device Electrical Surface Treatment HF SpotTEC Single (Tantec).

### Testing Equipment

Spectrophotometer: Cary 4000 UV-Vis. double-beam spectrophotometer, ISO/EN 8980-3:2013 (Agilent)
Light Transmittance and Haze Measuring Meter: TH-100, ASTM D1003/D1044 (Hangzhou CHN Spec Technology Co., Ltd.)
Thickness measurements: ThetaMetrisis layer thickness analyzer.

### Example 1: Corona Surface Treatment Procedure

The head of the corona treatment device (Tantec) was set at 1 cm from the surface of the ophthalmic lens and then was activated for 10 seconds. The process was performed twice before various coating materials were applied on the ophthalmic lens.

### Example 2: Procedure for Primer Application Using Spin-Coating

The ophthalmic lens was attached to the vacuum chuck of the spin coating apparatus. The spinning of the ophthalmic lens was performed at a spinning speed of 3000 rpm, an acceleration of 1000 rpm/sec, for 10 seconds.

### Example 3: Procedure for Application of Recipience Layer Using Spin-Coating

The ophthalmic lens was attached to the vacuum chuck of the spin coating apparatus. The spinning of the ophthalmic device was performed at a spinning speed of 800 rpm, an acceleration of 500 rpm/sec, for 10 seconds.

### Example 3A: Procedure for Application of Overcoat Using Spin-Coating

The ophthalmic lens was attached to the vacuum chuck of the spin coating apparatus. The spinning of the ophthalmic device was performed at a spinning speed of 1800 rpm, an acceleration of 800 rpm/sec, for 10 seconds.

### Example 3B: Procedure for Application of Hardcoat Using Spin-Coating

The ophthalmic lens was attached to the vacuum chuck of the spin coating apparatus. The spinning of the ophthalmic device was performed at a spinning speed of 1500 rpm, an acceleration of 500 rpm/sec, for 10 seconds.

### Example 4: Optimization of the Ink-Jetting Parameters

The Dimatix™ print head was pre-heated to 40° C. The drop characteristics were then optimized for each photochromic ink using a stroboscope mounted on the printer (camera and light source synchronized with the jetting frequency). The waveform was optimized for each photochromic ink, jetted at a frequency of 0.5-3 kHz. The distance between the printhead and the substrate was 0.6-1.0 mm. The jetting resulted in a drop size of about 50 micrometers (on the test substrate). The resolution was set at 300 dots per inch (dpi).

### Example 5A: Jetting of a Photochromic Ink onto the Recipience Layer

An optical construction having photochromic functionality was prepared by printing (by means of the Fujifilm Dimatix™ Inkjet printer) an ink-jet compatible ink containing a photochromic dye onto a recipience layer covered lens substrate, preferably utilizing the ink-jetting optimization technique of Example 4. The optical construction was prepared by ink-jetting an array of ink drops containing the photochromic dye such that the distance between the center of a first drop to the center of the adjacently jetted drop was 100 to 200 micrometers. This distance can be adjusted as desired. To control the viscosity at jetting and the spreading of the drops, both the printhead and the substrate were heated to 40° C. The photochromic ink may optionally contain one or more softening agents.

### Example 5B: Jetting of Multiple Photochromic Inks onto the Recipience Layer

An optical construction having dual photochromic functionality was prepared by printing (by means of the Fujifilm Dimatix™ Inkjet printer) two different inks, each ink containing a different photochromic dye, preferably utilizing the ink-jetting optimization technique of Example 4. The optical construction was prepared in a two-step process in which an array of ink drops containing the first dye was printed such that the drops were disposed whereby the distance between the center of a first drop to the center of the adjacently jetted drop was typically 100 to 200 micrometers. To control the viscosity at jetting and the spreading of the drops, both the printhead and the substrate were heated to 40° C.

The second dye was added to the layer by jetting drops of the second ink containing the second dye between the drops of the first array of drops. The drops of the second ink were printed at the same general conditions described above, but were jetted so as to be disposed at a distance of 50 micrometers from the drops of the first ink, measured from the center of the ink drop of the first ink to the center of the ink drop of the second ink.

Each of the photochromic inks may optionally contain one or more softening agents. The softening agents of each photochromic ink may be different (i.e., chemically different) from one another. One exemplary purpose for using different softening agents is to improve compatibility with respect to the individual photochromic ink formulations. Another exemplary purpose is to modify the relative fading time kinetics of the photochromic inks, when disposed within the recipience layer. This may be of particular importance when it is desirable to maintain a fairly constant overall color during the fading phase of two or more colors of photochromic dyes disposed within the recipience layer or ophthalmic substrate.

### Example 6: Jetting of Photochromic Inks onto the Recipience Layer: Photochromic Color Intensity

Using the procedure of Example 5A and the method of Example 5B, multiple photochromic ink drops of two or more photochromic inks were applied to various lenses coated with the recipience formulations provided hereinbelow to produce an optical construction having a photochromic dye(s) containing recipience layer. In some cases a single layer of ink-jet ink was applied, but typically, 2-80 layers, and more typically, 5-50 layers of photochromic ink were applied, as arrays, in a drop-on-drop fashion. Drying was then performed at 60° C. for 60 minutes.

### Example 6B: Jetting of Softening Agent onto the Recipience Layer

As described hereinabove, softening agent may be selectively applied to the recipience layer surface independently from the photochromic ink, e.g., using a different printhead or printhead cartridge. In the examples provided below, this method was performed using a dedicated printhead cartridge for the softening agent.

The printing system was manually controlled such that the drops of softening agent would fully overlap with the photochromic ink drops of the first photochromic ink on the surface of the recipience layer.

### Example 6C: Jetting of Softening Agent onto the Recipience Layer

The printing was effected according to Example 6B, but was controlled such that the drops of softening agent were jetted onto the surface of the recipience layer prior to the jetting of the photochromic ink drops of the first photochromic ink.

### Example 7

30 grams of TPM solvent were mixed with 67.8 grams of PMA solvent in a 200 ml glass beaker equipped with a magnetic stirrer. After mixing the components for 5 minutes at room temperature, 0.2 grams of surfactant BYK®-333 were added to the solvent mixture while mixing. 2 grams of Reversacol Midnight Gray dye were then added while mixing. Mixing was continued for another 20 minutes at 60° C. to produce the photochromic ink, which was subsequently filtered with a syringe filter (0.45 micrometer).

### Example 8

30 grams of TPM solvent were mixed with 68.8 grams of PMA solvent in a 200 ml glass beaker equipped with a magnetic stirrer. After mixing the components for 5 minutes at room temperature, 0.2 grams of surfactant BYK®-333 were added to the solvent mixture while mixing. 1 gram of Emoltene™ 3GO plasticizer was then added while mixing. Mixing was continued for another 20 minutes at 60° C. to produce the 1% solution of plasticizer, which solution was subsequently filtered with a syringe filter (0.45 micrometer).

### Example 9

30 grams of TPM solvent were mixed with 67.8 grams of PMA solvent in a 200 ml glass beaker equipped with a magnetic stirrer. After mixing the components for 5 minutes at room temperature, 0.2 grams of surfactant BYK®-333 were added to the solvent mixture while mixing. 2 grams of DEHP plasticizer were then added while mixing. Mixing was continued for another 20 minutes at 60° C. to produce the 2% solution of plasticizer, which solution was subsequently filtered with a syringe filter (0.45 micrometer).

### Example 10

30 grams of TPM solvent were mixed with 67.8 grams of PMA solvent in a 200 ml glass beaker equipped with a magnetic stirrer. After mixing the components for 5 minutes at room temperature, 0.2 grams of surfactant BYK®-333 were added to the solvent mixture while mixing. 2 grams of DEHTP plasticizer were then added while mixing. Mixing was continued for another 20 minutes at 60° C. to produce the 2% solution of plasticizer, which solution was subsequently filtered with a syringe filter (0.45 micrometer).

### Example 11

30 grams of TPM solvent were mixed with 67.8 grams of PMA solvent in a 200 ml glass beaker equipped with a magnetic stirrer. After mixing the components for 5 minutes at room temperature, 0.2 grams of surfactant BYK®-333 were added to the solvent mixture while mixing. 2 gram of Palatinol N plasticizer was then added while mixing. Mixing was continued for another 20 minutes at 60° C. to produce the 2% solution of plasticizer, which solution was subsequently filtered with a syringe filter (0.45 micrometer).

### Example 12

30 grams of TPM solvent were mixed with 64.8 grams of PMA solvent in a 200 ml glass beaker equipped with a magnetic stirrer. After mixing the components for 5 minutes at room temperature, 0.2 grams of surfactant BYK®-333 were added to the solvent mixture while mixing. 5 gram of Palatinol 10-P plasticizer was then added while mixing. Mixing was continued for another 20 minutes at 60° C. to produce the 5% solution of plasticizer, which solution was subsequently filtered with a syringe filter (0.45 micrometer).

### Example 13

30 grams of TPM solvent were mixed with 67.8 grams of PMA solvent in a 200 ml glass beaker equipped with a magnetic stirrer. After mixing the components for 5 minutes at room temperature, 0.2 grams of surfactant BYK®-358 were added to the solvent mixture while mixing. 2 grams of Reversacol Leather Brown dye were then added while mixing. Mixing was continued for another 20 minutes at 60° C. to produce the photochromic ink, which was subsequently filtered with a syringe filter (0.45 micrometer).

### Example 14

30 grams of TPM solvent were mixed with 65.8 grams of PMA solvent in a 200 ml glass beaker equipped with a magnetic stirrer. After mixing the components for 5 minutes at room temperature, 0.2 grams of surfactant BYK®-358 were added to the solvent mixture while mixing. 2 grams of Reversacol Midnight Gray dye and 2 grams of Reversacol Amazon Green dye were then added while mixing. Mixing was continued for another 20 minutes at 60° C. to produce the photochromic ink, which was subsequently filtered with a syringe filter (0.45 micrometer).

### Example 15

30 grams of TPM solvent were mixed with 66.8 grams of PMA solvent in a 200 ml glass beaker equipped with a magnetic stirrer. After mixing the components for 5 minutes at room temperature, 0.2 grams of surfactant BYK®-358 were added to the solvent mixture while mixing, followed by 2 grams of Reversacol Midnight Gray dye and 1 gram of Emoltene™ 3GO plasticizer. Mixing was continued for another 20 minutes at 60° C. to produce the photochromic ink, which was subsequently filtered with a syringe filter (0.45 micrometer).

### Example 16

30 grams of TPM solvent were mixed with 66.8 grams of PMA solvent in a 200 ml glass beaker equipped with a magnetic stirrer. After mixing the components for 5 minutes at room temperature, 0.2 grams of surfactant BYK®-358 were added to the solvent mixture while mixing, followed by 2 grams of Reversacol Amazon Green dye and 1 gram of Pevalen plasticizer. Mixing was continued for another 20 minutes at 60° C. to produce the photochromic ink, which was subsequently filtered with a syringe filter (0.45 micrometer).

### Example 17

30 grams of TPM solvent were mixed with 66.8 grams of PMA solvent in a 200 ml glass beaker equipped with a magnetic stirrer. 1 gram of Pearlcoat DIPP 119 was added and mixing ensued for 2 hours at 60° C. 0.2 grams of surfactant BYK®-358 were added, while mixing, followed by 2 grams of Reversacol Amazon Green dye. Mixing was continued for another 20 minutes at 60° C. to produce the photochromic ink, which was subsequently filtered with a syringe filter (0.45 micrometer).

### Example 18

30 grams of TPM solvent were mixed with 64.8 grams of PMA solvent in a 200 ml glass beaker equipped with a magnetic stirrer. After mixing the components for 5 minutes, 0.2 grams of surfactant BYK®-358 were added to the solvent mixture while mixing. 2 grams of Reversacol Midnight Gray dye, 2 grams of Reversacol Amazon Green dye and 1 gram of Emoltene™ 3GO plasticizer were then added while mixing. Mixing was continued for another 20 minutes at 60° C. to produce the photochromic ink, which was subsequently filtered with a syringe filter (0.45 micrometer).

### Example 19

30 grams of TPM solvent were mixed with 60.8 grams of PMA solvent in a 200 ml glass beaker equipped with a magnetic stirrer. After mixing the components for 5 minutes, 0.2 grams of surfactant BYK®-358 were added to the solvent mixture while mixing. 2 grams of Reversacol Midnight Gray dye, 2 grams of Reversacol Amazon Green dye and 5 grams of Jayflex DIDP plasticizer were then added while mixing. Mixing was continued for another 20 minutes at 60° C. to produce the photochromic ink, which was subsequently filtered with a syringe filter (0.45 micrometer).

### Example 20

30 grams of TPM solvent were mixed with 60.8 grams of PMA solvent in a 200 ml glass beaker equipped with a magnetic stirrer. After mixing the components for 5 minutes, 0.2 grams of surfactant BYK®-358 were added to the solvent mixture while mixing. 2 grams of Reversacol Midnight Gray dye, 2 grams of Reversacol Amazon Green dye and 5 grams Pevalen plasticizer were then added while mixing. Mixing was continued for another 20 minutes at 60° C. to produce the photochromic ink, which was subsequently filtered with a syringe filter (0.45 micrometer).

### Example 21

30 grams of TPM solvent were mixed with 60.8 grams of PMA solvent in a 200 ml glass beaker equipped with a magnetic stirrer. After mixing the components for 5 minutes, 0.2 grams of surfactant BYK®-358 were added to the solvent mixture while mixing. 2 grams of Reversacol Midnight Gray dye, 2 grams of Reversacol Amazon Green dye and 5 grams of Jayflex MB10 plasticizer were then added while mixing. Mixing was continued for another 20 minutes at 60° C. to produce the photochromic ink, which was subsequently filtered with a syringe filter (0.45 micrometer).

### Example 22

30 grams of TPM solvent were mixed with 66.8 grams of PMA solvent in a 200 ml glass beaker equipped with a magnetic stirrer. 1 gram of Laropal® A-81 was added and mixing ensued for 2 hours at 60° C. 0.2 grams of surfactant BYK®-358 were added to the mixture while mixing, followed by 2 grams of Reversacol Amazon Green dye. Mixing was continued for another 20 minutes at 60° C. to produce the photochromic ink, which was subsequently filtered with a syringe filter (0.45 micrometer).

### Example 23

30 grams of TPM solvent were mixed with 66.3 grams of PMA solvent in a 200 ml glass beaker equipped with a magnetic stirrer. 1.5 grams of Pearlbond 360 were added and mixing ensued for 2 hours at 60° C. 0.2 grams of surfactant BYK®-358 were added to the mixture while mixing, followed by 2 grams of Reversacol Amazon Green dye. Mixing was continued for another 20 minutes at 60° C. to produce the photochromic ink, which was subsequently filtered with a syringe filter (0.45 micrometer).

### Example 24

30 grams of TPM solvent were mixed with 66.8 grams of PMA solvent in a 200 ml glass beaker equipped with a magnetic stirrer. 1 gram of SETALUX® 2127 XX-60 was added and mixing ensued for 2 hours at 60° C. 0.2 grams of surfactant BYK®-358 were added to the mixture while mixing, followed by 2 grams of Reversacol Amazon Green dye. Mixing was continued for another 20 minutes at 60° C. to produce the photochromic ink, which was subsequently filtered with a syringe filter (0.45 micrometer).

### Example 25

30 grams of TPM solvent were mixed with 65.8 grams of PMA solvent in a 200 ml glass beaker equipped with a magnetic stirrer. 2 grams of Lubrijet™ T800 PU dispersion were added and mixing ensued for 2 hours at 60° C. 0.2 grams of surfactant BYK®-358 were added to the mixture while mixing, followed by 2 grams of Reversacol Corn Yellow dye. Mixing was continued for another 20 minutes at 60° C. to produce the photochromic ink, which was subsequently filtered with a syringe filter (0.45 micrometer).

### Example 26

30 grams of TPM solvent were mixed with 66.8 grams of PMA solvent in a 200 ml glass beaker equipped with a magnetic stirrer. 1 gram of Lubrijet™ T340 acrylic emulsion was added and mixing ensued for 2 hours at 60° C. 0.2 grams of surfactant BYK®-358 were added to the mixture while mixing, followed by 2 grams of Reversacol Midnight Gray dye. Mixing was continued for another 20 minutes at 60° C. to produce the photochromic ink, which was subsequently filtered with a syringe filter (0.45 micrometer).

### Example 27

30 grams of TPM solvent were mixed with 66.8 grams of PMA solvent in a 200 ml glass beaker equipped with a magnetic stirrer. 1 gram of Paraplex® A-8000 was added and mixing ensued for 2 hours at 60° C. 0.2 grams of surfactant BYK®-358 were added to the mixture while mixing. 2 grams of Reversacol Amazon Green dye were then added while mixing. Mixing was continued for another 20 minutes at 60° C. to produce the photochromic ink, which was subsequently filtered with a syringe filter (0.45 micrometer).

### Example 28

30 grams of TPM solvent were mixed with 62.8 grams of PMA solvent in a 200 ml glass beaker equipped with a magnetic stirrer. 5 grams of Paraplex® A-8000 were added and mixing ensued for 2 hours at 60° C. 0.2 grams of surfactant BYK®-358 were added to the mixture while mixing. 2 grams of Reversacol Amazon Green dye were then added while mixing. Mixing was continued for another 20 minutes at 60° C. to produce the photochromic ink, which was subsequently filtered with a syringe filter (0.45 micrometer).

### Example 29

30 grams of TPM solvent were mixed with 66.8 grams of PMA solvent in a 200 ml glass beaker equipped with a magnetic stirrer. 1 gram of Paraplex® A-8200 was added and mixing ensued for 2 hours at 60° C. 0.2 gram of surfactant BYK®-358 were added to the mixture while mixing. 2 grams of Reversacol Amazon Ocean Blue dye were then added while mixing. Mixing was continued for another 20 minutes at 60° C. to produce the photochromic ink, which was subsequently filtered with a syringe filter (0.45 micrometer).

### Example 30

30 grams of TPM solvent were mixed with 62.8 grams of PMA solvent in a 200 ml glass beaker equipped with a magnetic stirrer. 5 grams of Paraplex® A-8200 were added and mixed for 2 hours at 60° C. 0.2 grams of surfactant BYK®-358 were added to the mixture while mixing. 2 grams of Reversacol Amazon Ocean Blue dye were then added while mixing. Mixing was continued for another 20 minutes at 60° C. to produce the photochromic ink, which was subsequently filtered with a syringe filter (0.45 micrometer).

### Example 31

30 grams of TPM solvent were mixed with 67.5 grams of EB solvent in a 200 ml glass beaker equipped with a magnetic stirrer. After mixing the components for 5 minutes, 0.5 grams of surfactant EFKA®-3277 were added to the solvent mixture while mixing, followed by 2 grams of Reversacol Amazon Green dye. Mixing was continued for another 20 minutes at 60° C. to produce the photochromic ink, which was subsequently filtered with a syringe filter (0.45 micrometer).

### Example 32

30 grams of TPM solvent were mixed with 67.65 grams of MEK solvent in a 200 ml glass beaker equipped with a magnetic stirrer. After mixing the components for 5 minutes, 0.35 grams of surfactant EFKA® SL 3200 were added to the solvent mixture while mixing, followed by 2 grams of Reversacol Corn Yellow dye. Mixing was continued for another 20 minutes at 60° C. to produce the photochromic ink, which was subsequently filtered with a syringe filter (0.45 micrometer).

### Example 33

30 grams of DBA solvent were mixed with 67.9 grams of PMA solvent in a 200 ml glass beaker equipped with a magnetic stirrer. After mixing the components for 5 minutes, 0.1 grams of surfactant BYK®-358 were added to the solvent mixture while mixing, followed by 2 grams of Reversacol Leather Brown dye. Mixing was continued for another 20 minutes at 60° C. to produce the photochromic ink, which was subsequently filtered with a syringe filter (0.45 micrometer).

### Example 34

30 grams of Augeo SL-191 solvent were mixed with 67.9 grams of PMA solvent in a 200 ml glass beaker equipped with a magnetic stirrer. After mixing the components for 5 minutes, 0.1 grams of surfactant BYK®-358 were added to the solvent mixture while mixing 2 grams of Reversacol Amazon Green dye were added while mixing. Mixing was continued for another 20 minutes at 60° C. to produce the photochromic ink, which was subsequently filtered with a syringe filter (0.45 micrometer).

### Example 34A

30 grams of Augeo SL-191 solvent were mixed with 67.7 grams of PM solvent in a 200 ml glass beaker equipped with a magnetic stirrer. After mixing the components for 5 minutes, 0.3 grams of surfactant EFKA®-3778 were added to the solvent mixture while mixing. 2 grams of Reversacol Amazon Green dye were then added, while mixing, and the mixing was continued for another 20 minutes at 60° C. to produce the photochromic ink, which was subsequently filtered with a syringe filter (0.45 micrometer).

### Example 35

30 grams of Augeo SL-191 solvent were mixed with 67.8 grams of n-hexylglycol solvent in a 200 ml glass beaker equipped with a magnetic stirrer. After mixing the components for 5 minutes, 0.2 grams of surfactant BYK®-3760 were added to the solvent mixture while mixing. 2 grams of Reversacol Midnight Gray were then added, while mixing, and the mixing was continued for another 20 minutes at 60° C. to produce the photochromic ink, which was subsequently filtered with a syringe filter (0.45 micrometer).

### Example 36

30 grams of DPnP solvent were mixed with 67.9 grams of PM solvent in a 200 ml glass beaker equipped with a magnetic stirrer. After mixing the components for 5 minutes, 0.1 grams of surfactant BYK®-346 were added to the solvent mixture while mixing 1 gram of Reversacol Midnight Gray dye and 1 gram of Reversacol Amazon Green dye were added while mixing. Mixing was continued for another 20 minutes at 60° C. to produce the photochromic ink, which was subsequently filtered with a syringe filter (0.45 micrometer).

### Example 37

65 grams of Joncryl® 1532 were mixed with 20 grams of water in a 200 ml glass beaker equipped with a magnetic stirrer. Then 9.5 grams of EB solvent, 4.8 grams of DPM solvent and 0.2 grams of BYK® 024 were added while mixing. After mixing the components for 5 minutes, 0.5 grams of surfactant BYK®-346 were added to the mixture and the mixing was continued for another 10 minutes at 30° C.

### Example 38

70 grams of Joncryl® 1534 were mixed with 15 grams of water in a 200 ml glass beaker equipped with a magnetic stirrer. Then 9.5 grams of EB solvent, 4.8 grams of DPM solvent and 0.2 grams of BYK® 024 were added while mixing. After mixing the components for 5 minutes, 0.5 grams of surfactant EFKA® 3200 were added to the mixture and the mixing was continued for another 10 minutes at 30° C.

### Example 39

75 grams of Joncryl® 2110 were mixed with 10 grams of water in a 200 ml glass beaker equipped with a magnetic stirrer. Then 10 grams of EB solvent, 4.5 grams of DPM solvent and 0.25 grams of BYK® 044 were added while mixing. After mixing the components for 5 minutes, 0.25 grams of surfactant BYK® 346 were added to the mixture and the mixing was continued for another 10 minutes at 30° C.

### Example 40

The corona surface treatment procedure was performed on a Trivex® (PPG) lens made of urethane-based pre-polymer, according to Example 1.

### Example 41

The corona surface treatment procedure was performed on a polycarbonate lens according to Example 1.

### Example 42

The corona surface treatment procedure of Example 1 was performed on a polycarbonate lens that was pre-coated with a hardcoat.

### Example 43

The corona surface treatment procedure of Example 1 was performed on a Trivex® (PPG) lens that was pre-coated with a hardcoat.

### Example 44

The corona surface treatment procedure of Example 1 was performed on a CR-39® (PPG) lens made of poly(allyl diglycol carbonate) (PADC) that was pre-coated with a hardcoat.

### Example 45

Onto a polycarbonate lens was applied Versamid® PUR 1010 as a primer. Spin coating was effected according to Example 2, and a calculated (average) wet thickness of 2.86 μm was obtained. The wet layer was then subjected to thermal drying and curing in a Venticell ECO forced air oven at 60° C. for 10 minutes and then at 100° C. for 10 minutes, to produce a primer layer having a thickness of 1.0 μm.

### Example 46

Onto a polycarbonate lens was applied Laroflex® HS-9000 as a primer. Spin coating was effected according to Example 2, and a calculated wet thickness of 2.1 μm was obtained. The wet layer was then subjected to thermal drying and curing in a Venticell ECO forced air oven at 60° C. for 10 minutes and then at 100° C. for 10 minutes, to produce a primer layer having a thickness of about 1.5 μm.

### Example 47

Onto a polycarbonate lens was applied the Joncryl® 1534 formulation of Example 38 as a primer. Spin coating was effected according to Example 2, and a calculated wet thickness of 0.65 μm was obtained. The wet layer was then subjected to thermal drying and curing in a Venticell ECO forced air oven at 60° C. for 10 minutes and then at 100° C. for 10 minutes, to produce a primer layer having a thickness of about 0.2 μm.

### Example 48

Onto a Trivex® (PPG) lens that had been pre-coated with a hardcoat was applied the Joncryl® 1532 formulation of Example 37 as a primer. Spin coating was effected according to Example 2, and a calculated wet thickness of 1.48 μm was obtained. The wet layer was then subjected to thermal drying and curing in a Venticell ECO forced air oven at 60° C. for 10 minutes and then at 100° C. for 10 minutes, to produce a primer layer having a thickness of about 0.5 μm.

### Example 49

Onto a CR-39® (PPG) lens that had been pre-coated with a hardcoat was applied the Joncryl® 2110 formulation of Example 39 as a primer. Spin coating was effected according to Example 2, and a calculated wet thickness of 6.71 μm was obtained. The wet layer was then subjected to thermal drying and curing in a Venticell ECO forced air oven at 60° C. for 10 minutes and then at 100° C. for 10 minutes, to produce a primer layer having a thickness of about 2.5 μm.

### Example 50

Onto the Trivex® (PPG) lens that had been corona-treated according to Example 43 was applied the Joncryl® 1534 formulation of Example 38 as a primer. Spin coating was effected according to Example 2, and a calculated wet thickness of 2.6 μm was obtained. The wet layer was then subjected to thermal drying and curing in a Venticell ECO forced air oven at 60° C. for 10 minutes and then at 100° C. for 10 minutes, to produce a primer layer having a thickness of about 0.8 μm.

### Example 51

Onto the polycarbonate lens that had been corona-treated according to Example 42 was applied the Joncryl® 1534 formulation of Example 38 as a primer. Spin coating was effected according to Example 2. The wet layer was then subjected to thermal drying and curing in a Venticell ECO forced air oven at 60° C. for 10 minutes and then at 100° C. for 10 minutes.

### Example 52

Onto the CR-39® lens that had been corona-treated according to Example 44 was applied the Joncryl® 1534 formulation of Example 38 as a primer. Spin coating was effected according to Example 2. The wet layer was then subjected to thermal drying and curing in a Venticell ECO forced air oven at 60° C. for 10 minutes and then at 100° C. for 10 minutes.

### Example 53

Onto the Trivex® lens of Example 18 was applied the Joncryl® 2110 formulation of Example 39 as a primer. Spin coating was effected according to Example 2. The wet layer was then subjected to thermal drying and curing in a Venticell ECO forced air oven at 60° C. for 10 minutes and then at 100° C. for 10 minutes.

### Example 54

50 grams of BR344 were mixed with 45 grams of IBOA in a 200 ml glass beaker equipped with a magnetic stirrer. Subsequently, 5 grams of TPO were added, and the mixing was continued for another 10 minutes at 30° C.

### Example 55

50 grams of BR345 were mixed with 45 grams of HEMA in a 200 ml glass beaker equipped with a magnetic stirrer. Subsequently, 5 grams of TPO were added, and the mixing was continued for another 10 minutes at 30° C.

### Example 56

50 grams of BR990 were mixed with 45 grams of HEMA in a 200 ml glass beaker equipped with a magnetic stirrer. Subsequently, 5 grams of TPO were added, and the mixing was continued for another 10 minutes at 30° C.

### Example 57

50 grams of BR374 of were mixed with 45 grams of SR484 in a 200 ml glass beaker equipped with a magnetic stirrer. Subsequently, 5 grams of TPO were added, and the mixing was continued for another 10 minutes at 30° C.

### Example 58

30.5 grams of TPM solvent were mixed with 55 grams of PMA solvent in a 200 ml glass beaker equipped with a magnetic stirrer. After mixing the components for 5 minutes, 0.5 grams of surfactant EFKA® SL 3200 were added to the solvent mixture while mixing. 10 grams of Pearlbond™ 360 were then added while continuing to mix. Mixing was continued for another 40 minutes at 60° C. to produce the softener formulation, which was subsequently filtered with a syringe filter (0.45 micrometer).

### Example 59

30.5 grams of TPM solvent were mixed with 55 grams of PMA solvent in a 200 ml glass beaker equipped with a magnetic stirrer. After mixing the components for 5 minutes, 0.5 grams of surfactant EFKA® SL 3035 were added to the solvent mixture while mixing. 10 grams of Pearlcoat™ DIPP 119 were then added while continuing to mix. Mixing was continued for another 40 minutes at 60° C. to produce the softener formulation, which was subsequently filtered with a syringe filter (0.45 micrometer).

### Example 60

33 grams of TPM solvent were mixed with 52.5 grams of PMA solvent in a 200 ml glass beaker equipped with a magnetic stirrer. After mixing the components for 5 minutes, 0.5 grams of surfactant EFKA® SL 3035 were added to the solvent mixture while mixing. 10 grams of Pearlcoat™ DIPP 119 were added while continuing to mix. Mixing was continued for another 40 minutes at 60° C. to produce the softener formulation, which was subsequently filtered with a syringe filter (0.45 micrometer).

### Example 61

30.5 grams of TPM solvent were mixed with 55 grams of PMA solvent in a 200 ml glass beaker equipped with a magnetic stirrer. After mixing the components for 5 minutes, 0.5 grams of surfactant EFKA® SL 3200 were added to the solvent mixture while mixing. 10 grams of Pearlbond™ 360 were then added while continuing to mix. Mixing was continued for another 40 minutes at 60° C. to produce the softener formulation, which was subsequently filtered with a syringe filter (0.45 micrometer).

### Example 62

30.5 grams of TPM solvent were mixed with 55 grams of PMA solvent in a 200 ml glass beaker equipped with a magnetic stirrer. After mixing the components for 5 minutes, 0.5 grams of surfactant EFKA® SL 3035 were added to the solvent mixture while mixing. 10 grams of Laropal® A-81 were added while continuing to mix. Mixing was continued for another 40 minutes at 60° C. to produce the softener formulation, which was subsequently filtered with a syringe filter (0.45 micrometer).

### Example 63

Onto a polycarbonate lens was applied Kamthane K-1492 as a recipience layer formulation. Spin coating was effected according to Example 3. The wet layer, having a calculated average thickness of 12.0 μm, was then subjected to thermal drying and curing in a Venticell ECO forced air oven at 60° C. for 10 minutes and then at 100° C. for 20 minutes.

### Example 64

Onto a polycarbonate lens was applied Alberdingk® UC-90 as a recipience layer formulation. Spin coating was effected according to Example 3. The wet layer was then subjected to thermal drying and curing in a Venticell ECO forced air oven at 60° C. for 10 minutes and then at 100° C. for 20 minutes. The dry (measured) thickness was about 5.8 μm.

### Example 65

Onto a polycarbonate lens was applied Alberdingk® U-6100VP as a recipience layer formulation. Spin coating was effected according to Example 3. The wet layer, having a calculated average thickness of 21.7 μm, was then subjected to thermal drying and curing in a Venticell ECO forced air oven at 60° C. for 10 minutes and then at 100° C. for 20 minutes. The dry (average calculated) thickness was about 7.8 μm.

### Example 66

Onto a polycarbonate lens was applied Alberdingk® U-6100VP as a recipience layer formulation. Spin coating was effected according to Example 3. The wet layer, having a calculated average thickness of 26.1 μm, was then subjected to thermal drying and curing in a Venticell ECO forced air oven at 60° C. for 10 minutes and then at 100° C. for 20 minutes. The dry (average calculated) thickness was about 9.4 μm.

### Example 67

Onto a polycarbonate lens was applied Lubrijet™ N240 as a recipience layer formulation. Spin coating was effected according to Example 3. The wet layer, having a calculated average thickness of 30.0 μm, was then subjected to thermal drying and curing in a Venticell ECO forced air oven at 60° C. for 10 minutes and then at 100° C. for 20 minutes. The dry (average calculated) thickness was about 12 μm.

### Example 68

Onto a polycarbonate lens was applied Alberdingk APU-10610 as a recipience layer formulation. Spin coating was effected according to Example 3. The wet layer, having a calculated average thickness of 16.2 μm, was then subjected to thermal drying and curing in a Venticell ECO forced air oven at 60° C. for 10 minutes and then at 100° C. for 20 minutes. The dry (average calculated) thickness was about 5.5 μm.

### Example 69

Onto the primed Trivex® (PPG) lens of Example 48 was applied Alberdingk® U-6150 as a recipience layer formulation. Spin coating was effected according to Example 3. The wet layer was then subjected to thermal drying and curing in a Venticell ECO forced air oven at 60° C. for 10 minutes and then at 100° C. for 20 minutes. The dry (average calculated) thickness was about 4.5 μm.

### Example 70

Onto a Trivex® (PPG) lens was applied JONCRYL 2136-A as a recipience layer formulation. Spin coating was effected according to Example 3. The wet layer, having a calculated average thickness of 21.4 μm, was then subjected to thermal drying and curing in a Venticell ECO forced air oven at 60° C. for 10 minutes and then at 100° C. for 20 minutes. The dry (average calculated) thickness was about 9 μm.

### Example 71

Onto a Trivex® (PPG) lens was applied JONCRYL 2121 as a recipience layer formulation. Spin coating was effected according to Example 3. The wet layer, having a calculated average thickness of 19.6 μm, was then subjected to thermal drying and curing in a Venticell ECO forced air oven at 60° C. for 10 minutes and then at 100° C. for 20 minutes. The dry (average calculated) thickness was about 10 μm.

### Example 72

Onto the primed CR-39® lens of Example 49 was applied JONCRYL 2136-A as a recipience layer formulation. Spin coating was effected according to Example 3. The wet layer, having a calculated average thickness of 10.7 μm, was then subjected to thermal drying and curing in a Venticell ECO forced air oven at 60° C. for 10 minutes and then at 100° C. for 20 minutes. The dry (average calculated) thickness was about 4.5 μm.

### Example 73

Onto a polycarbonate lens was applied Alberdingk® U 9900 as a recipience layer formulation. Spin coating was effected according to Example 3. The wet layer, having a calculated average thickness of 25.45 μm, was then subjected to thermal drying and curing in a Venticell ECO forced air oven at 60° C. for 10 minutes and then at 100° C. for 20 minutes.

### Example 74

Onto a polycarbonate lens was applied Alberdingk® U 9150 as a recipience layer formulation. Spin coating was effected according to Example 3. The wet layer was then subjected to thermal drying and curing in a Venticell ECO forced air oven at 60° C. for 10 minutes and then at 100° C. for 20 minutes. The dry (average calculated) thickness was about 9.8 μm.

### Example 75

Onto a polycarbonate lens was applied the formulation of Example 54 as a recipience layer. Spin coating was then effected according to Example 3, and the wet layer was subjected to UV curing using the UV LED Curing System of Phoseon Technology for 30 seconds. The dry (average calculated) thickness was about 5.7 μm.

### Example 76

Onto a polycarbonate lens was applied the formulation of Example 55 as a recipience layer. Spin coating was then effected according to Example 3, and the wet layer was subjected to UV curing using the UV LED Curing System of Phoseon Technology for 30 seconds. The dry (average calculated) thickness was about 4.1 μm.

### Example 77

Onto a CR-39® lens was applied the formulation of Example 56 as a recipience layer. Spin coating was then effected according to Example 3, and the wet layer was subjected to UV curing using the UV LED Curing System of Phoseon Technology for 30 seconds. The dry (average calculated) thickness was about 9.8 μm.

### Example 78

Onto the primed polycarbonate lens of Example 46 was applied the formulation of Example 57 as a recipience layer. Spin coating was then effected according to Example 3, and the wet layer was subjected to UV curing using the UV LED Curing System of Phoseon Technology for 30 seconds. The dry (average calculated) thickness was about 7.8 μm.

### Example 79

Onto a CR-39® lens was applied Alberdingk® AC 3797 as a recipience layer formulation. Spin coating was effected according to Example 3. The wet layer was then subjected to thermal drying in a Venticell ECO forced air oven at 60° C. for 30 minutes. The dry (average calculated) thickness was about 3.7 μm.

### Example 80

Onto a polycarbonate lens was applied Alberdingk® U 9150 as a recipience layer formulation. Spin coating was effected according to Example 3. The wet layer was then subjected to thermal drying in a Venticell ECO forced air oven at 60° C. for 30 minutes. The dry (average calculated) thickness was about 11.9 μm.

### Example 81

Onto the corona surface treated Trivex® lens of Example 43 was applied Kamthane K-1492 as a recipience layer formulation. Spin coating was effected according to Example 3. The wet layer was then subjected to thermal drying in a Venticell ECO forced air oven at 60° C. for 30 minutes. The dry (average calculated) thickness was about 28.2 μm.

### Example 82

Onto the primed, corona surface treated, Trivex® lens of Example 50 was applied Alberdingk® U 9900 as a recipience layer formulation. Spin coating was effected according to Example 3. The wet layer was then subjected to thermal drying in a Venticell ECO forced air oven at 60° C. for 30 minutes. The dry (average calculated) thickness was about 9.6 μm.

### Example 83

Onto the primed, corona surface treated, Trivex® lens of Example 53 was applied JONCRYL 2121 as a recipience layer formulation. Spin coating was effected according to Example 3. The wet layer was then subjected to thermal drying in a Venticell ECO forced air oven at 60° C. for 30 minutes. The dry (average calculated) thickness was about 7.1 μm.

### Example 84

Onto the primed, corona surface treated, polycarbonate lens of Example 51 was applied JONCRYL 2121 as a recipience layer formulation. Spin coating was effected according to Example 3. The wet layer was then subjected to thermal drying in a Venticell ECO forced air oven at 60° C. for 30 minutes. The dry (average calculated) thickness was about 6.9 μm.

### Example 85

Onto the primed, corona surface treated, CR-39® lens of Example 52 was applied Alberdingk® UC 90 as a recipience layer formulation. Spin coating was effected according to Example 3. The wet layer was then subjected to thermal drying in a Venticell ECO forced air oven at 60° C. for 30 minutes. The dry (average calculated) thickness was about 4.4 μm.

### Example 86

Onto a CR-39® lens was applied was applied Alberdingk® CUR 991 as a recipience layer formulation. Spin coating was effected according to Example 3. The wet layer was then subjected to thermal drying in a Venticell ECO forced air oven at 60° C. for 30 minutes. The dry (average calculated) thickness was about 13.4 μm.

### Examples 87-125

### Ink-Jetting onto the Recipience Layer-Covered Lens with PC Ink Containing Softening Agent

After optimizing the inkjetting parameters according to the procedure of Example 4, the photochromic dye inkjet ink formulations of the above-provided Examples, which contain photochromic dye, and optionally a softening agent, were inkjetted onto various recipience layer covered lens substrates described hereinabove.

In Examples 87 to 102, a single photochromic dye containing inkjet ink formulation was inkjetted onto the recipience layer surface, according to the procedure of Example 5A.

In Examples 103 to 125, two different photochromic ink formulations were inkjetted onto the recipience layer surface, according to the procedure of Example 5B. In order to increase the intensity of the photochromic color(s), the ink-drop arrays were applied in a drop-on-drop fashion (4 to 72 drop-on-drops), according to the procedure of Example 6.

Examples 87 to 125 are summarized in the Table provided below:

| Example | | | | | Number of Drop- | | | |
|---|---|---|---|---|---|---|---|---|
| No. | LENS MATERIAL/RECIPIENCE LAYER | | PC INK #1 | PC INK #2 | on-Drops (DoD) | | | |
| Ex. 87 | polycarbonate/Kamthane K-1492 | Example 63 | Example 20 | — | 4 | | | |
| Ex. 88 | polycarbonate/UC90 | Example 64 | Example 7 | — | 8 | | | |
| Ex. 89 | polycarbonate/U 6100 | Example 65 | Example 35 | — | 12 | | | |
| Ex. 90 | polycarbonate/U 6100 | Example 66 | Example 34 | — | 16 | | | |
| Ex. 91 | polycarbonate/Lubrijet ™N240 | Example 67 | Example 36 | — | 24 | | | |
| Ex. 92 | polycarbonate/APU 10610 | Example 68 | Example 34A | — | 36 | | | |
| Ex. 93 | primed Trivex ®/U 6150 | Example 69 | Example 17 | — | 36 | | | |
| Ex. 94 | Trivex ®/JONCRYL 2136-A | Example 70 | Example 30 | — | 48 | | | |
| Ex. 95 | Trivex ®/JONCRYL 2121 | Example 71 | Example 17 | — | 4 | | | |
| Ex. 96 | primed CR-39 ®/JONCRYL 2136-A | Example 72 | Example 18 | — | 8 | | | |
| Ex. 97 | polycarbonate/U 9900 | Example 73 | Example 17 | — | 12 | | | |
| Ex. 98 | polycarbonate/U 9150 | Example 74 | Example 18 | — | 24 | | | |
| Ex. 99 | polycarbonate/BR-344 | Example 75 | Example 19 | — | 24 | | | |
| Ex. 100 | polycarbonate/BR-345 | Example 76 | Example 18 | — | 48 | | | |
| Ex. 101 | CR-39 ®/BR-990 | Example 77 | Example 25 | — | 24 | | | |
| Ex. 102 | primed polycarbonate/BR-374 | Example 78 | Example 12 | — | 36 | | | |
| Ex. 103-106 | CR-39 ®/AC3797 | Example 79 | Example 16 | Example 25 | 12 | 24 | 36 | 48 |
| Ex. 107-110 | polycarbonate/U 9150 | Example 80 | Example 11 | Example 35 | 12 | 36 | 60 | 72 |
| Ex. 111 | Trivex ®/Kamthane K-1492 | Example 81 | Example 24 | Example 25 | 12 | | | |
| Ex. 112 | Trivex ®/U 9900 | Example 82 | Example 20 | Example 31 | 72 | | | |
| Ex. 113-116 | Trivex ®/JONCRYL 2121 | Example 83 | Example 19 | Example 32 | 4 | 8 | 24 | 48 |
| Ex. 117 | pr. polycarbonate/JONCRYL 2121 | Example 84 | Example 21 | Example 13 | 60 | | | |
| Ex. 118 | CR-39 ®/UC90 | Example 85 | Example 11 | Example 25 | 8 | | | |
| Ex. 119-121 | CR-39 ®/CUR 991 | Example 86 | Example 29 | Example 32 | 24 | 48 | 60 | |
| Ex. 122 | polycarbonate/BR-344 | Example 75 | Example 22 | Example 32 | 36 | | | |
| Ex. 123 | polycarbonate/U 9150 | Example 80 | Example 28 | Example 32 | 60 | | | |
| Ex. 124 | polycarbonate/UC90 | Example 64 | Example 18 | Example 32 | 60 | | | |
| Ex. 125 | primed Trivex ®/U 6150 | Example 69 | Example 24 | Example 32 | 60 | | | |

### Examples 126-130

### Ink-Jetting onto the Recipience Layer-Covered Lens with PC Ink and Separate Softening Agent

After optimizing the inkjetting parameters according to the procedure of Example 4, the photochromic dye inkjet ink formulations of the above-provided Examples, which contain photochromic dye, and optionally a softening agent, were inkjetted onto various recipience layer covered lens substrates described hereinabove. A separate softening agent was inkjetted on top of the photochromic ink formulations as indicated in the Table provided below, which summarizes Examples 126 to 130.

| | | | | Relative Position | | Number of |
|---|---|---|---|---|---|---|
| Example | | | | between PC and | | Drop-on-Drops |
| No. | LENS MATERIAL/RECIPIENCE LAYER | | PC INK #1 | Softener Drops | PC INK #2 | (DoD) |
| Ex. 126 | polycarbonate/U 6100 | Example 65 | Example 13 | concentric | — | 4 |
| Ex. 127 | primed Trivex ®/U 6150 | Example 69 | Example 7 | concentric | — | 8 |
| Ex. 128 | polycarbonate/U 9150 | Example 74 | Example 14 | 5 micrometers apart | — | 12 |
| Ex. 129 | polycarbonate/BR-344 | Example 75 | Example 31 | concentric | Example 25 | 16 |
| Ex. 130 | pr. polycarbonate/ | Example 84 | Example 33 | 10 micrometers apart | Example 32 | 24 |
| | JONCRYL 2121 | | | | | |

### Example 131

Onto the coated polycarbonate lens produced in Example 88 was applied SETALUX® 17-7202 as an overcoat formulation. Spin coating was effected according to Example 3A. The wet layer, having a calculated average thickness of 15 μm, was then subjected to thermal drying in a Venticell ECO forced air oven at 60° C. for 30 minutes. The dry (average calculated) thickness was about 7.5 μm.

### Example 132

Onto the coated CR-39® lens produced in Example 118 was applied Alberdingk® APU 10600 as an overcoat formulation. Spin coating was effected according to Example 3A. The wet layer, having a calculated average thickness of 6.1 μm, was then subjected to thermal drying in a Venticell ECO forced air oven at 60° C. for 30 minutes. The dry (average calculated) thickness was about 2.0 μm.

### Example 133

Onto the primed and coated polycarbonate lens produced in Example 117 was applied Bondthane™ UD-620 as an overcoat formulation. Spin coating was effected according to Example 3A. The wet layer, having a calculated average thickness of 7.3 μm, was then subjected to thermal drying in a Venticell ECO forced air oven at 60° C. for 30 minutes. The dry (average calculated) thickness was about 2.5 μm.

### Example 134

Onto the corona-treated, primed and coated Trivex® lens produced in Example 93 was applied SETALUX® 17-1246 as an overcoat formulation. Spin coating was effected according to Example 3A. The wet layer, having a calculated average thickness of 8.7 μm, was then subjected to thermal drying in a Venticell ECO forced air oven at 60° C. for 30 minutes. The dry (average calculated) thickness was about 3.5 μm.

### Example 135

Onto the primed and coated polycarbonate lens produced in Example 130 was applied Joncryl® 9530-A as an overcoat formulation. Spin coating was effected according to Example 3A. The wet layer, having a calculated average thickness of 4.6 μm, was then subjected to thermal drying in a Venticell ECO forced air oven at 60° C. for 30 minutes. The dry (average calculated) thickness was about 1.8 μm.

### Example 136

Onto the coated Trivex® lens produced in Example 111 was applied Joncryl® 617-A as an overcoat formulation. Spin coating was effected according to Example 3A. The wet layer, having a calculated average thickness of 6.5 μm, was then subjected to thermal drying in a Venticell ECO forced air oven at 60° C. for 30 minutes. The dry (average calculated) thickness was about 3 μm.

### Example 137

Onto the coated lens produced in Example 132 was applied CrystalCoat™ TC-3000 as a hardcoat. Spin coating was effected according to Example 3B. The wet layer, having a calculated average thickness of 10 μm, was then subjected to thermal drying in a Venticell ECO forced air oven at 60° C. for 30 minutes. The dry (average calculated) thickness was about 2 μm.

### Example 138

Onto the coated lens produced in Example 133 was applied CrystalCoat™ MP-1154D as a hardcoat. Spin coating was effected according to Example 3B. The wet layer, having a calculated average thickness of 26.2 μm, was then subjected to thermal drying in a Venticell ECO forced air oven at 60° C. for 30 minutes. The dry (average calculated) thickness was about 4.7 μm.

### Example 139

Onto the coated lens produced in Example 136 was applied CrystalCoat™ MP-2020B as a hardcoat. Spin coating was effected according to Example 3B. The wet layer, having a calculated average thickness of 14.4 μm, was then subjected to thermal drying in a Venticell ECO forced air oven at 60° C. for 30 minutes. The dry (average calculated) thickness was about 3.2 μm.

### Example 140

### Measuring Haze & % Transmittance

After calibrating the T-100 instrument, the Target lens was measured (uncoated reference lens). In Sample mode, the coated lens was then tested. The instrument then displayed the following results of the coated and uncoated lenses: % Transmittance, Δ % Transmittance, Haze, and Δ Haze. Lower delta values between the coated and uncoated lens indicate good optical clarity/transparency.

### Example 141

### Measuring Photochromic Properties

Spectrophotometric studies were conducted using a Cary 4000 UV-Vis. double-beam spectrophotometer. The light source was a UV-LED lamp (395 nm). Activation and fading properties & kinetics were characterized. In the spectrophotometric studies, the coated samples were characterized against an uncoated reference slide or lens. Spectrum data were normally collected in the range 350-700 nm at a resolution of 1 nm. Kinetics measurements of activation and fading rates were performed at the wavelength of maximal absorbance for each photochromic dye, with a typical resolution of 0.2 seconds. The measurements were initiated while the UV-LED lamp is off. After 3-5 seconds, the UV-LED lamp was turned on for 120-180 seconds to attain maximal absorbance. The lamp was then turned off, and monitoring of the fading was conducted.

As used herein in the specification and in the claims section that follows, the term “percent”, or “%”, refers to percent by weight, unless specifically indicated otherwise.

As used herein in the specification and in the claims section that follows, the terms “anti-glare”, “anti-reflectance”; “anti-fog”; “ultraviolet absorber”; “photochromic”, and the like, unless otherwise specified, are meant as used in the art of optical substrate coatings.

As used herein in the specification and in the claims section that follows, the term “anti-scratch”, with respect to a material such as a formulation or a coating, refers to a material whose dried and cured coating exhibits a haze value of less than 6%, using the following taber abrasion properties, according to ASTM D1004-08: CS 10 F wheel, 500 g Load, 500 cycles.

The term “ratio”, as used herein in the specification and in the claims section that follows, refers to a weight ratio, unless specifically indicated otherwise.

The “thickness” of a layer or a plurality of layers at a particular location is measured in the direction that is normal (N) to the lens substrate at that location.

Various types of thin-film thickness measurements are know to those of skill in the art. For example, single-spot thickness measurements may be performed by spectral reflectance or by spectroscopic ellipsometry.

In addition, mapping of thin-film surfaces and calculation of average thicknesses of such films may be performed using these techniques.

The “average thickness” of a wet layer may be determined as follows: when a volume of material vol covers a surface area of a surface having an area SA with a wet layer−the thickness of the wet layer is assumed to be vol SA.

The “average thickness” of a dried film may be calculated as follows: when a volume of material vol that is x % liquid, by weight, wets or covers a surface area SA of a surface, and all the liquid is evaporated away to convert the wet layer into a dry film, the thickness of the dry film is calculated as:

vol/ρ_{wet layer}(100−x)/(SA·ρ_{dry layer})

where ρ_{wet layer} is the specific gravity of the wet layer and ρ_{dry layer} is the specific gravity of the dry layer. This calculation requires a knowledge of various properties of the wet coating material of the film, e.g., the specific gravity. Typically, the specific gravities may be assumed to be 1.

It will be appreciated by those of skill in the art that the various layers disposed on the optical or ophthalmic surface (e.g., the lens surface) of the present invention are generally of a substantially even thickness, hence, the “average thickness” may be determined by evaluating one or more spot thicknesses on the film or layer.

As used herein in the specification and in the claims section that follows, the term “characteristic”, with respect to an ink dot dimension such as height, length or diameter, refers to the maximal value of that dot dimension. By way of example, for a square dot, 30 micrometers on a side, the characteristic diameter would be the diagonal, i.e., 30√2=42.4 micrometers. For a dot having some peaks on the top surface, distal to the optical substrate, the dot height would be the maximum height measured normal to the top surface of the substrate. For a plurality of dots, the characteristic dimension is the average of the characteristic dimension of the individual dots within the plurality.

As used herein in the specification and in the claims section that follows, the term “average”, with respect to a dimension of a plurality of dots such as the height, length or diameter thereof, refers to the arithmetic mean of that dimension, and is calculated using the characteristic dimension for each dot in the plurality.

As used herein in the specification and in the claims section that follows, the term “primary plasticizer” is used essentially as understood in the art. Typically, a primary plasticizer enhances elongation, softness and flexibility of the polymer. A primary plasticizer may be highly compatible with polymers and may be added in large quantities.

As used herein in the specification and in the claims section that follows, the term “softening agent” is used essentially as understood in the art.

In some embodiments, the vapor pressure of the “softening agent” at 20° C. is at most 1 millibar or at most 0.45 millibar, and more typically, at most 0.25 millibar, or at most 0.15 millibar.

As used herein in the specification and in the claims section that follows, the term “adapted to soften” and the like is used essentially as understood in the art.

In some embodiments, when 5 grams of the softening agent are added to 100 grams of the polymer/pre-polymer formulation, the mechanical properties are improved (“softened”) by at least 5%, at least 7%, at least 10%, at least 15%, at least 20%, at least 25%, at least 35%, at least 50%, or at least 65%.

In some embodiments, the mechanical property is hardness (e.g., nanohardness), which is reduced by these amounts.

In some embodiments, the mechanical property is ultimate elongation (elongation %), which is increased by these amounts.

As used herein in the specification and in the claims section that follows, the term “photochromic dye concentration (C_{recipience})”, e.g., within the polymeric recipience layer may be calculated from the formulation quantities and concentrations, when known, or may be determined analytically, as will be appreciated by those of skill in the art.

As used herein, the intrinsic kinetics or time of transition (e.g., fading time) of photochromic dyes are measured at 25° C., and are readily determined by those of skill in the art. The information is often available from the manufacturers and/or suppliers of the photochromic dye.

As used herein in the specification and in the claims section that follows, the term “transparent”, typically with respect to a material, e.g., a material used in a coating, or as a substrate, may be determined according to ASTM D1003. Utilizing ASTM D1003, a material having a haze measurement of less than 2% and a total transmittance (Tₜ) of at least 85% is considered “transparent”. More typically, the haze is at most 1.5% or at most 1.0%. More typically, Tₜ is at least 90% or at least 95%. Yet more typically, the haze is at most 1.0% and Tₜ is at least 95%.

As used herein in the specification and in the claims section that follows, the term “liquid medium” and the like refers to a medium that is liquid at its temperature of use. For example, the liquid medium in an ink-jet ink jetted at 38° C. is a liquid at 38° C. A “liquid medium” is typically liquid at 25° C.

In the context of the present application and claims, the phrase “at least one of A and B” is equivalent to an inclusive “or”, and includes any one of “only A”, “only B”, or “A and B”. Similarly, the phrase “at least one of A, B, and C” is equivalent to an inclusive “or”, and includes any one of “only A”, “only B”, “only C”, “A and B”, “A and C”, “B and C”, or “A and B and C”.

As used herein in the specification and in the claims section that follows, the terms “top”, “bottom”, “above”, “below”, “upper”, “lower”, “height” and “side” and the like are utilized for convenience of description or for relative orientation, and are not necessarily intended to indicate an absolute orientation in space.

### ADDITIONAL EMBODIMENTS

Additional Embodiments and Clauses are provided hereinbelow.

Embodiment 1. A method of producing an ophthalmic construction, the method comprising:
(a) depositing a wet recipience layer on an ophthalmic surface of an ophthalmic substrate;
(b) after said wet recipience layer has cured to form an at least partially cured, typically continuous recipience layer, applying, onto a recipience surface of said recipience layer:
   a first photochromic dye disposed in a first photochromic ink containing
   a first liquid medium, and
   at least a first softening agent adapted to soften said recipience layer; and
(c) after said at least one photochromic ink has at least partially penetrated the upper surface of said recipience layer, and after said first photochromic ink has at least partially dried to form a photochromic dye containing recipience layer, applying a first polymer formulation on said photochromic dye containing recipience layer to form an overcoat layer.

Embodiment 2. The method of Embodiment 1, wherein said first photochromic ink is applied selectively to produce a first region within said recipience layer that is relatively rich in said first photochromic dye, with respect to a second region within said recipience layer that is relatively poor in said first photochromic dye.

Embodiment 3. The method of Embodiment 2, wherein said first photochromic ink is applied selectively to produce an uneven hardness in said photochromic dye containing recipience layer, whereby a second local hardness in said second region exceeds a first local hardness in said first region.

Embodiment 4. The method of any one of Embodiments 1 to 3, wherein said first photochromic ink further contains said first softening agent.

Embodiment 5. The method of any one of Embodiments 1 to 4, wherein said applying of said first photochromic dye is performed using a first formulation in a first discrete step, and said applying of said at least a first softening agent is performed using a second formulation in a second discrete step, said first formulation being different from said second formulation.

Embodiment 5A. A method of producing an ophthalmic construction, the method comprising:
(a) depositing a wet recipience layer on an ophthalmic surface of an ophthalmic substrate;
(b) after said wet recipience layer has cured to form an at least partially cured, typically continuous recipience layer, applying at least one photochromic ink including a first photochromic ink and optionally, a second photochromic ink, onto a first portion of a recipience surface of said recipience layer;
each of said first and second photochromic inks containing:
   (i) a photochromic dye; and
   (ii) a liquid medium,
said photochromic dye disposed within said liquid medium;
(c) after said wet recipience layer has cured to form an at least partially cured, recipience layer, applying, to said recipience layer, a softening agent adapted to soften said recipience layer; and
(d) after said at least one photochromic ink has at least partially penetrated the upper surface of said recipience layer, and after said at least one photochromic ink has at least partially dried to form a photochromic dye containing recipience layer, applying a first polymer formulation on said photochromic dye containing recipience layer to form said overcoat layer;
wherein said applying of said first photochromic ink on to said recipience surface is performed selectively to produce a first region that is relatively rich in said first photochromic dye with respect to a second region that is relatively poor in said first photochromic dye; and
wherein said applying of said softening agent on to said recipience surface is performed selectively to produce an uneven hardness in said photochromic dye containing recipience layer, whereby a first local hardness in said first region exceeds a second local hardness in said second region.

Embodiment 6. A method of producing an ophthalmic construction, the method comprising:
(a) depositing a wet recipience layer on an ophthalmic surface of an ophthalmic substrate;
(b) after said wet recipience layer has cured to form an at least partially cured, typically continuous recipience layer, applying at least a first photochromic ink, onto a recipience surface of said recipience layer;
wherein said at least a first photochromic ink contains a first photochromic dye disposed within a first liquid medium, and a softening agent adapted to soften said recipience layer;
(c) optionally, after said wet recipience layer has cured to form said at least partially cured, recipience layer, applying, onto said recipience surface, at least a second photochromic ink containing a second photochromic dye disposed within a second liquid medium, said second photochromic ink optionally containing a second softening agent adapted to soften said recipience layer; and
(d) after said at least a first photochromic ink has at least partially penetrated the upper surface of said recipience layer, and after said at least a first photochromic ink has at least partially dried to form a photochromic dye containing recipience layer, applying a first polymer formulation on said photochromic dye containing recipience layer to form an overcoat layer.

Embodiment 7. The method of Embodiment 6, wherein said applying of said first photochromic ink is performed selectively to produce a first region within said recipience layer that is relatively rich in said first photochromic dye, with respect to a second region within said recipience layer that is relatively poor in said first photochromic dye.

Embodiment 8. The method of Embodiment 7, wherein said applying of said first photochromic ink is performed selectively to produce an uneven hardness in said photochromic dye containing recipience layer, whereby a second local hardness in said second region exceeds a first local hardness in said first region.

Embodiment 9. The method of any one of the previous Embodiments (i.e., Embodiments 1 to 8), the method further comprising: after said wet recipience layer has cured to form said at least partially cured, recipience layer, applying, onto said recipience surface, said at least a second photochromic ink containing said second photochromic dye disposed within said second liquid medium.

Embodiment 9A. The method of any one of Embodiments 7 to 9, wherein said at least a first photochromic ink is at least two first photochromic inks (first photochromic ink 1A and first photochromic ink 1B), wherein said first photochromic ink 1A exhibits a first characteristic or intrinsic fading time (Tf1A) and said first photochromic ink 1B exhibits a second characteristic or intrinsic fading time (Tf1B), and wherein a or said uneven hardness is produced so as to change (typically promote or produce) a fading time differential (delta Tf=Tf1A−Tf1B) between photochromic inks 1A and 1B within said recipience layer.

Embodiment 9B. The method of Embodiment 7, wherein said applying of said first photochromic ink is performed selectively to produce an uneven hardness in said photochromic dye containing recipience layer, whereby a second local hardness in said second region exceeds a first local hardness in said first region, the method further comprising: after said wet recipience layer has cured to form said at least partially cured, recipience layer, applying, onto said recipience surface, said at least a second photochromic ink containing said second photochromic dye disposed within said second liquid medium, wherein said first photochromic ink exhibits a first characteristic or intrinsic fading time (Tf1) and said second photochromic ink exhibits a second characteristic or intrinsic fading time (Tf2), and wherein said uneven hardness is produced so as to change a fading time differential (delta Tf=Tf1−Tf2) between said first and second photochromic inks within said recipience layer.

Embodiment 9C. The method of Embodiment 9B, wherein said uneven hardness is produced so as to reduce said fading time differential (delta Tf), optionally by at least 10%, at least 20%, at least 35%, at least 45%, or at least 60%.

Embodiment 9D. The method of any one of the previous Embodiments, wherein a or said second photochromic ink contains a or said second softening agent adapted to soften said recipience layer.

Embodiment 9E. The method of any one of the previous Embodiments, wherein the ophthalmic surface includes the outer broad surface of the ophthalmic substrate (e.g., the outwardly facing broad surface of a lens such as an eyeglass lens).

Embodiment 9F. The method of any one of the previous Embodiments, wherein the ophthalmic surface includes the inner broad surface of the ophthalmic substrate (e.g., the inwardly facing broad surface of a lens such as an eyeglass lens).

Embodiment 9G. The method of Embodiment 9E or Embodiment 9F, wherein the respective outer broad surface or the respective inner broad surface on which the at least a first photochromic ink is applied, is a convex surface.

Embodiment 9H. The method of Embodiment 9E or Embodiment 9F, wherein the respective outer broad surface or the respective inner broad surface on which the at least a first photochromic ink is applied, is a concave surface.

Embodiment 10. The method of any one of the previous Embodiments, wherein the ultimate elongation of said wet recipience layer, after complete curing, is at most 475%.

Embodiment 11. The method of Embodiment 10, wherein said ultimate elongation, after complete curing, is at most 425%.

Embodiment 12. The method of Embodiment 11, wherein said ultimate elongation is at most 350%.

Embodiment 13. The method of Embodiment 11, wherein said ultimate elongation is at most 300%.

Embodiment 14. The method of Embodiment 11, wherein said ultimate elongation is at most 250%.

Embodiment 15. The method of Embodiment 11, wherein said ultimate elongation is at most 200%.

Embodiment 16. The method of Embodiment 11, wherein said ultimate elongation is at most 175%.

Embodiment 17. The method of any one of Embodiments 10 to 16, wherein the ultimate elongation of said wet recipience layer, after complete curing, is at least 20%.

Embodiment 18. The method of Embodiment 17, wherein the ultimate elongation, after complete curing, is at least 40%.

Embodiment 19. The method of Embodiment 18, wherein the ultimate elongation is at least 60%.

Embodiment 20. The method of Embodiment 18, wherein the ultimate elongation is at least 80%.

Embodiment 21. The method of Embodiment 18, wherein the ultimate elongation is at least 100%.

Embodiment 22. The method of any one of Embodiments 1 to 9, wherein the ultimate elongation of said wet recipience layer, after complete curing, is within a range of 30 to 425%.

Embodiment 23. The method of Embodiment 22, wherein said ultimate elongation is within a range of 50 to 425%.

Embodiment 24. The method of Embodiment 22, wherein said ultimate elongation is within a range of 70 to 400%.

Embodiment 25. The method of Embodiment 22, wherein said ultimate elongation is within a range of 70 to 350%.

Embodiment 26. The method of Embodiment 22, wherein said ultimate elongation is within a range of 70 to 300%.

Embodiment 27. The method of any one of Embodiments 22 to 26, wherein said ultimate elongation is at least 90%.

Embodiment 28. The method of any one of the previous Embodiments, wherein the König hardness of said wet recipience layer, after complete curing, is at least 30.

Embodiment 29. The method of Embodiment 28, wherein said König hardness after complete curing, is at least 40.

Embodiment 30. The method of Embodiment 29, wherein said König hardness is at least 50.

Embodiment 31. The method of Embodiment 29, wherein said König hardness is at least 60.

Embodiment 32. The method of Embodiment 29, wherein said König hardness is at least 70.

Embodiment 33. The method of Embodiment 29, wherein said König hardness is at least 80.

Embodiment 34. The method of Embodiment 29, wherein said König hardness is at least 90.

Embodiment 35. The method of Embodiment 29, wherein said König hardness is at least 100.

Embodiment 36. The method of Embodiment 29, wherein said König hardness is at least 110.

Embodiment 37. The method of Embodiment 29, wherein said König hardness is at least 120.

Embodiment 38. The method of Embodiment 29, wherein said König hardness is at least 130.

Embodiment 39. The method of any one of the previous Embodiments, wherein the König hardness of said wet recipience layer, after complete curing, is at most 180.

Embodiment 40. The method of Embodiment 39, wherein said König hardness after complete curing, is at most 170.

Embodiment 41. The method of Embodiment 40, wherein said König hardness is at most 160.

Embodiment 42. The method of Embodiment 40, wherein said König hardness is at most 150.

Embodiment 43 The method of Embodiment 40, wherein said König hardness is at most 140.

Embodiment 44. The method of any one of the previous Embodiments, wherein the pencil hardness of said wet recipience layer, after complete curing, is at least B.

Embodiment 45. The method of Embodiment 44, wherein said pencil hardness, after complete curing, is at least HB.

Embodiment 46. The method of Embodiment 45, wherein said pencil hardness is at least F.

Embodiment 47. The method of Embodiment 45, wherein said pencil hardness is at least H.

Embodiment 48. The method of any one of the previous Embodiments, wherein the pencil hardness of said wet recipience layer, after complete curing, is at most 4H.

Embodiment 49. The method of Embodiment 48, wherein said pencil hardness is at most 3H.

Embodiment 50. The method of Embodiment 48, wherein said pencil hardness is at most 2H.

Embodiment 51. The method of any one of Embodiments 48 and 49, wherein said pencil hardness is at least 2H.

Embodiment 52. The method of any one of Embodiments 44 to 46, wherein said pencil hardness is at most H.

Embodiment 53. The method of any one of the previous Embodiments, wherein said first photochromic ink is applied selectively to produce an uneven hardness in said photochromic dye containing recipience layer, whereby a second local hardness H2 in said second region exceeds a first local hardness H1 in said first region, wherein said second local hardness H2 exceeds said first local hardness, H1, by a differential hardness, ê, according to:

ê=100·(H2−H1)/H2.

Embodiment 53A. The method of Embodiment 53, wherein ê is at least 2%.

Embodiment 54. The method of Embodiment 53, wherein ê is at least 4%.

Embodiment 55. The method of Embodiment 53, wherein ê is at least 6%.

Embodiment 56. The method of Embodiment 53, wherein ê is at least 8%.

Embodiment 57. The method of Embodiment 53, wherein ê is at least 10%.

Embodiment 58. The method of Embodiment 53, wherein ê is at least 12%.

Embodiment 59. The method of Embodiment 53, wherein ê is at least 15%.

Embodiment 60. The method of Embodiment 53, wherein ê is at least 20%.

Embodiment 61. The method of Embodiment 53, wherein ê is at least 25%.

Embodiment 62. The method of Embodiment 53, wherein ê is at least 35%.

Embodiment 63. The method of Embodiment 53, wherein ê is at least 50%.

Embodiment 64. The method of Embodiment 53, wherein ê is at least 70%.

Embodiment 65. The method of any one of Embodiments 53 to 64, wherein ê is at most 97%.

Embodiment 66. The method of Embodiment 65, wherein ê is at most 90%.

Embodiment 67. The method of Embodiment 65, wherein ê is at most 80%.

Embodiment 68. The method of any one of Embodiments 53 to 64, wherein ê is within a range of 2 to 95%.

Embodiment 69. The method of Embodiment 68, wherein said range is 2 to 85%.

Embodiment 70. The method of Embodiment 68, wherein ê is within a range of 5 to 80%.

Embodiment 71. The method of Embodiment 68, wherein ê is within a range of 10 to 75%.

Embodiment 72. The method of Embodiment 68, wherein ê is within a range of 15 to 75%.

Embodiment 73. The method of Embodiment 68, wherein ê is within a range of 20 to 75%.

Embodiment 74. The method of Embodiment 68, wherein ê is within a range of 30 to 70%.

Embodiment 75. The method of any one of Embodiments 68 to 74, wherein said differential hardness is a differential König hardness.

Embodiment 76. The method of any one of Embodiments 53 to 75, wherein said second local hardness, H2 in said second region exceeds said first local hardness, H1, in said first region by a differential pencil hardness, êHp of at least 1 standard pencil hardness unit.

Embodiment 77. The method of Embodiment 76, wherein êHp is at most 4 standard pencil hardness units.

Embodiment 78. The method of Embodiment 76, wherein êHp is at most 3 standard pencil hardness units.

Embodiment 79. The method of Embodiment 77 or 78, wherein êHp is at least 2 standard pencil hardness units.

Embodiment 80. The method of Embodiment 79, wherein êHp is within a range of 1 to 2 standard pencil hardness units.

Embodiment 81. The method of any one of Embodiments 53 to 74, wherein said differential hardness is a differential hardness as determined by indentation characterization.

Embodiment 82. The method of Embodiment 81, wherein said differential hardness is determined by nanoindentation.

Embodiment 83. The method of any one of Embodiments 1 to 82, wherein said applying of at least one photochromic ink or photochromic dye is performed by ink-jetting.

Embodiment 84. The method of Embodiment 83, wherein said ink-jetting includes drop-on-demand ink-jetting.

Embodiment 85. The method of Embodiment 83, wherein said ink-jetting includes piezoelectric ink-jetting.

Embodiment 86. The method of Embodiment 83, wherein said ink-jetting includes thermal ink-jetting.

Embodiment 87. The method of any one of Embodiments 1 to 82, wherein said applying of at least one photochromic ink or photochromic dye is performed by at least one microvalve in a microvalve system.

Embodiment 88. The method of Embodiment 87, wherein said microvalve system is adapted to deliver a dispensing volume below 50 nanoliters.

Embodiment 89. The method of Embodiment 87, wherein said microvalve system is adapted to deliver a dispensing volume below 20 nanoliters.

Embodiment 90. The method of Embodiment 87, wherein said microvalve system is adapted to deliver a dispensing volume below 10 nanoliters.

Embodiment 91. The method of Embodiment 87, wherein said microvalve system is adapted to deliver a dispensing volume below 5 nanoliters.

Embodiment 92. The method of any one of Embodiments 87 to 91, wherein said at least one microvalve is electromagnetically actuated.

Embodiment 93. The method of any one of Embodiments 87 to 91, wherein said at least one microvalve is piezoelectrically actuated.

Embodiment 94. The method of any one of Embodiments 1 to 82, wherein said applying of at least one photochromic ink is performed by spraying.

Embodiment 95. The method of Embodiment 94, wherein said spraying is ultrasonic spraying.

Embodiment 96. The method of Embodiment 95, wherein said ultrasonic spraying produces a drop size within a range of 2 to 80 microliters.

Embodiment 97. The method of any one of Embodiments 1 to 96, wherein said applying of said first photochromic dye or said first photochromic ink is digitally applying.

Embodiment 98. The method of any one of Embodiments 1 to 97, wherein said applying of said first photochromic dye or said first photochromic ink is performed according to a predetermined image pattern.

Embodiment 99. The method of any one of Embodiments 1 to 98, wherein a weight content of said softening agent within said first photochromic ink is within a range of 1 to 15%.

Embodiment 100. The method of Embodiment 99, wherein said weight content of said softening agent is at least 1.5%.

Embodiment 101. The method of Embodiment 99, wherein said weight content of said softening agent is at least 2%.

Embodiment 102. The method of Embodiment 99, wherein said weight content of said softening agent is at least 2.5%.

Embodiment 103. The method of any one of Embodiments 99 to 102, wherein said weight content of said softening agent is at most 12%.

Embodiment 104. The method of Embodiment 102, wherein said weight content of said softening agent is at most 10%.

Embodiment 105. The method of Embodiment 102, wherein said weight content of said softening agent is at most 8%.

Embodiment 106. The method of Embodiment 102, wherein said weight content of said softening agent is at most 7%.

Embodiment 107. The method of Embodiment 102, wherein said weight content of said softening agent is at most 6%.

Embodiment 108. The method of Embodiment 102, wherein said weight content of said softening agent is at most 5%.

Embodiment 109. The method of any one of Embodiments 1 to 108, wherein a weight ratio Rs-pᵢₙₖ of said softening agent to said first photochromic dye within said first photochromic ink is within a range of 0.2 to 5.0.

Embodiment 110. The method of any one of Embodiments 1 to 109, wherein a weight ratio Rs-p_{layer} of said softening agent to said first photochromic dye, within said photochromic dye containing recipience layer, is within a range of 0.2 to 5.0.

Embodiment 111. The method of Embodiment 109 or Embodiment 110, wherein at least one of Rs-pᵢₙₖ and Rs-p_{layer} is at least 0.4.

Embodiment 112. The method of Embodiment 111, wherein at least one or both of Rs-pᵢₙₖ and Rs-p_{layer} is at least 0.6.

Embodiment 113. The method of Embodiment 111, wherein at least one or both of Rs-pᵢₙₖ and Rs-p_{layer} is at least 0.8.

Embodiment 114. The method of Embodiment 111, wherein at least one or both of Rs-pᵢₙₖ and Rs-p_{layer} is at least 1.0.

Embodiment 115. The method of Embodiment 111, wherein at least one or both of Rs-pᵢₙₖ and Rs-p_{layer} is at least 1.2.

Embodiment 116. The method of any one of Embodiments 109 to 115, wherein at least one or both of Rs-pᵢₙₖ and Rs-p_{layer} is at most 3.5.

Embodiment 117. The method of Embodiment 116, wherein Rs-p is at most 4.5.

Embodiment 118. The method of Embodiment 116, wherein Rs-p is at most 3.8.

Embodiment 119. The method of Embodiment 116, wherein Rs-p is at most 3.

Embodiment 120. The method of Embodiment 116, wherein Rs-p is at most 2.5.

Embodiment 121. The method of Embodiment 116, wherein Rs-p is at most 2.

Embodiment 122. The method of any one of Embodiments 1 to 121, wherein a weight ratio Rs-rl of said softening agent to said wet recipience layer, on a dry or solvent-free basis, is within a range of 0.02 to 0.3.

Embodiment 123. The method of Embodiment 122, wherein Rs-rl is at most 0.25.

Embodiment 124. The method of Embodiment 122, wherein Rs-rl is at most 0.22.

Embodiment 125. The method of Embodiment 122, wherein Rs-rl is at most 0.20.

Embodiment 126. The method of Embodiment 122, wherein Rs-rl is at most 0.17.

Embodiment 127. The method of Embodiment 122, wherein Rs-rl is at most 0.15.

Embodiment 128. The method of Embodiment 122, wherein Rs-rl is at most 0.12.

Embodiment 129. The method of Embodiment 122, wherein Rs-rl is at most 0.10.

Embodiment 130. The method of any one of Embodiments 122 to 129, wherein Rs-rl is at least 0.04.

Embodiment 131. The method of Embodiment 130, wherein Rs-rl is at least 0.06.

Embodiment 132. The method of any one of Embodiments 1 to 131, wherein said softening agent contains a plasticizer such as an external plasticizer.

Embodiment 133. The method of Embodiment 132, wherein said external plasticizer contains a primary plasticizer.

Embodiment 134. The method of Embodiment 132 or 133, wherein said softening agent is an organic softening agent.

Embodiment 135. The method of any one of Embodiments 132 to 134, wherein said softening agent contains an ester.

Embodiment 136. The method of Embodiment 135, wherein said ester includes an alkyl ester.

Embodiment 137. The method of Embodiment 135 or 136, wherein said ester includes an aryl ester.

Embodiment 138. The method of any one of Embodiments 135 to 137, wherein said ester includes a phthalate ester.

Embodiment 139. The method of any one of Embodiments 135 to 138, wherein said ester includes a terephthalate ester.

Embodiment 140. The method of any one of Embodiments 135 to 139, wherein said ester includes an orthophthalate ester.

Embodiment 141. The method of any one of Embodiments 135 to 140, wherein said ester includes a valerate ester.

Embodiment 142. The method of any one of Embodiments 135 to 141, wherein said ester includes an adipate ester.

Embodiment 143. The method of any one of Embodiments 135 to 142, wherein said ester includes a trimellitate ester.

Embodiment 144. The method of any one of Embodiments 135 to 143, wherein said ester includes an azelate ester.

Embodiment 145. The method of any one of Embodiments 135 to 144, wherein said ester includes a sebacate ester.

Embodiment 146. The method of any one of Embodiments 135 to 145, wherein said ester includes a polyester.

Embodiment 147. The method of any one of Embodiments 135 to 146, wherein said ester includes a phenyl ester.

Embodiment 148. The method of any one of Embodiments 135 to 147, wherein said ester includes a citrate ester.

Embodiment 149. The method of any one of Embodiments 135 to 148, wherein said ester includes a benzoate ester.

Embodiment 150. The method of Embodiment 149, wherein said benzoate ester is selected from the group consisting of at least one of diethylene benzoate, dipropyleneglycol, and iso-decyl benzoate.

Embodiment 151. The method of any one of Embodiments 1 to 150, wherein said softening agent includes a sulfonate.

Embodiment 152. The method of Embodiment 151, wherein said sulfonate includes a phenyl sulfonate.

Embodiment 153. The method of Embodiment 151 or 152, wherein said sulfonate includes an alkyl sulfonate.

Embodiment 154. The method of any one of Embodiments 151 to 153, wherein said sulfonate includes a phenyl alkyl sulfonate.

Embodiment 155. The method of any one of Embodiments 134 to 154, wherein said softening agent includes an epoxidized oil.

Embodiment 156. The method of any one of Embodiments 1 to 155, wherein said softening agent includes a polymeric softening agent.

Embodiment 157. The method of Embodiment 156, wherein said polymeric softening agent includes a polyadipate polyol.

Embodiment 158. The method of Embodiment 157, wherein said polyadipate polyol is selected from the group consisting of at least one of polyethylene adipate, polypropylene adipate, and polybutylene adipate.

Embodiment 159. The method of any one of Embodiments 156 to 158, wherein said polymeric softening agent includes a hexanedioic acid, polymer with 2,2-dimethyl-1,3-propanediol and 1,2 propanediol, isononyl ester.

Embodiment 160. The method of any one of Embodiments 156 to 159, wherein said polymeric softening agent includes a hexanedioic acid, polymer with 1,2-propanediol, octyl ester.

Embodiment 161. The method of any one of Embodiments 156 to 160, wherein said polymeric softening agent includes a hexanedioic acid, polymer with 1.2-propanediol, acetate.

Embodiment 162. The method of any one of Embodiments 156 to 161, wherein said polymeric softening agent includes a polysebacate.

Embodiment 163. The method of any one of Embodiments 156 to 162, wherein said polymeric softening agent includes a polyphthalate.

Embodiment 164. The method of any one of Embodiments 156 to 163, wherein said polymeric softening agent includes a dibasic acid glycol polyester and di-isooctyl phthalate.

Embodiment 165. The method of any one of Embodiments 1 to 164, wherein said softening agent includes an acrylic sol plasticizer.

Embodiment 166. The method of any one of Embodiments 1 to 165, wherein said softening agent is selected from the group consisting of at least one of diisononyl phthalate (DINP), diisodecyl phthalate (DIDP), diethylhexyl phthalate (DEHP), and di-n-octyl phthalate (DnOP).

Embodiment 167. The method of any one of Embodiments 1 to 166, wherein said softening agent is selected from the group consisting of at least one of DEHA, DINCH, and DOTP.

Embodiment 168. The method of any one of Embodiments 1 to 167, wherein said softening agent is selected from the group consisting of at least one of acetyl tributyl citrate (ATBC), di-2-ethylhexyl adipate, diisononyl cyclohexane-1,2-dicarboxylate, pentaerythritoltetravalerate (PETV), and di-2-ethylhexyl terephthalate (DEHT).

Embodiment 169. The method of any one of Embodiments 1 to 168, wherein said softening agent is selected from the group consisting of at least one of 2EHESBO, ASE, CMCHA, DBT, DEHCH, PETV, and TOTM.

Embodiment 170. The method of any one of Embodiments 1 to 169, wherein said softening agent includes a polyethylene glycol.

Embodiment 171. The method of Embodiment 170, wherein said polyethylene glycol has a molecular weight within a range of 400 to 8000 Daltons.

Embodiment 172. The method of any one of Embodiments 1 to 171, wherein said softening agent includes a trimethylsiloxy-terminated PDMS polymer.

Embodiment 173. The method of any one of Embodiments 1 to 172, wherein at least one of at least one of said wet recipience layer, said at least partially cured recipience layer, and said photochromic dye containing recipience layer, contains polyurethane.

Embodiment 173A. The method of any one of Embodiments 1 to 172, wherein said wet recipience layer, said at least partially cured recipience layer, and said photochromic dye containing recipience layer, contain polyurethane.

Embodiment 174. The method of Embodiment 173 or 173A, wherein said polyurethane is a thermoplastic polyurethane (TPU).

Embodiment 175. The method of any one of Embodiments 1 to 174, wherein at least one of at least one of said wet recipience layer, said at least partially cured recipience layer, and said photochromic dye containing recipience layer, contains a polydimethylsiloxane.

Embodiment 175a. The method of any one of the previous Embodiments, wherein said applying of said at least a first photochromic ink onto said recipience surface is performed as photochromic ink drops, e.g., by ink-jetting or by microvalves.

Embodiment 176. The method of Embodiment 175a, wherein said applying of said wet recipience layer is performed by ink-jetting.

Embodiment 177. The method of Embodiment 176, wherein said ink-jetting includes drop-on-demand ink-jetting.

Embodiment 178. The method of Embodiment 177, wherein said drop-on-demand ink-jetting includes piezoelectric ink-jetting.

Embodiment 179. The method of Embodiment 177, wherein said drop-on-demand ink-jetting includes thermal ink-jetting.

Embodiment 180. The method of any one of Embodiments 1 to 175, wherein said applying of said wet recipience layer is performed by at least one microvalve in a microvalve system.

Embodiment 181. The method of Embodiment 180, wherein said microvalve system is adapted to deliver a dispensing volume below 50 nanoliters.

Embodiment 182. The method of Embodiment 180, wherein said microvalve system is adapted to deliver a dispensing volume below 20 nanoliters.

Embodiment 183. The method of Embodiment 180, wherein said microvalve system is adapted to deliver a dispensing volume below 10 nanoliters.

Embodiment 184. The method of Embodiment 180, wherein said microvalve system is adapted to deliver a dispensing volume below 5 nanoliters.

Embodiment 185. The method of any one of Embodiments 180 to 184, wherein said at least one microvalve is electromagnetically actuated.

Embodiment 186. The method of any one of Embodiments 180 to 185, wherein said at least one microvalve is piezoelectrically actuated.

Embodiment 187. The method of any one of Embodiments 1 to 175, wherein said applying of said wet recipience layer is performed by spraying.

Embodiment 188. The method of Embodiment 187, wherein said spraying is ultrasonic spraying.

Embodiment 189. The method of Embodiment 188, wherein said ultrasonic spraying produces a drop size within a range of 2 to 80 microliters.

Embodiment 190. The method of any one of Embodiments 1 to 189, wherein said applying of said wet recipience layer is digitally applying.

Embodiment 191. The method of any one of Embodiments 1 to 190, wherein said applying of said wet recipience layer is performed according to a predetermined image pattern.

Embodiment 191A. The method of any one of Embodiments 1 to 191, wherein the applying of the photochromic ink drops of the photochromic ink is performed according to a pre-determined pattern such as a pre-determined digital pattern.

Embodiment 192. The method of any one of Embodiments 1 to 191A, wherein said wet recipience layer contains a polyurethane.

Embodiment 193. The method of any one of Embodiments 1 to 192, wherein said wet recipience layer contains or substantially consists of a polyurethane dispersion.

Embodiment 194. The method of any one of Embodiments 1 to 191, wherein said wet recipience layer contains a polyvinyl butyral.

Embodiment 195. The method of any one of Embodiments 1 to 191, wherein said wet recipience layer contains an acrylate.

Embodiment 196. The method of Embodiment 195, wherein said acrylate includes a urethane acrylate.

Embodiment 197. The method of Embodiment 195 or 196, wherein said acrylate includes a polyester acrylate.

Embodiment 198. The method of any one of Embodiments 195 to 197, wherein said acrylate includes a polyether acrylate.

Embodiment 199. The method of any one of the previous Embodiments, wherein said wet recipience layer has a thickness or an average thickness within a range of 2.5 to 80 μm.

Embodiment 200. The method of any one of the previous Embodiments, wherein said wet recipience layer has a thickness or an average thickness within a range of 3 to 60 μm.

Embodiment 201. The method of any one of the previous Embodiments, wherein said wet recipience layer has a thickness or an average thickness within a range of 3.5 to 50 μm.

Embodiment 201A. The method of any one of the previous Embodiments, wherein said first liquid medium contains a first solvent selected to penetrate the upper surface of said at least partially cured recipience layer.

Embodiment 201B. The method of Embodiment 201A, wherein the first solvent makes up at least 15%, at least 25%, or at least 40% of the first liquid medium.

Embodiment 201C. The method of any one of the previous Embodiments, wherein at least one photochromic dye, and optionally, each photochromic dye is fully dissolved in the cured recipience layer.

Embodiment 201D. The method of any one of the previous Embodiments, wherein at least one photochromic dye, and optionally, each photochromic dye is fully dissolved in the at least partially cured recipience layer.

Embodiment 201E. The method of any one of the previous Embodiments, wherein the solubility of at least one photochromic dye in the cured or the at least partially cured recipience layer is at least 5%, at least 7%, at least 10%, at least 12%, at least 15%, at least 20%, at least 25%, at least 30%, or at least 35%, on the basis of weight of the photochromic dye to total weight of the cured or the at least partially cured recipience layer.

Embodiment 201F. The method of Embodiment 201E, wherein the total solubility of all of the photochromic dyes within the recipience layer is at least 5%, at least 7%, at least 10%, at least 12%, at least 15%, at least 20%, at least 25%, at least 30%, at least 35%, at least 40%, or at least 35%, on the basis of weight of the photochromic dye to total weight of the cured or the at least partially cured recipience layer.

Embodiment 202. The method of any one of the previous Embodiments, further comprising, prior to said depositing, pre-treating a first surface of said ophthalmic substrate to form the ophthalmic surface.

Embodiment 203. The method of Embodiment 202, said pre-treating including a corona treatment.

Embodiment 203A. The method of any one of the previous Embodiments, wherein said photochromic dye containing recipience layer is a continuous photochromic dye containing recipience layer.

Embodiment 203B. The method of Embodiment 203A, wherein the photochromic dye is distributed in continuous fashion within said continuous photochromic dye containing recipience layer, along the (x-y) surface of the optical substrate.

Embodiment 203C. The method of Embodiment 203B, wherein the photochromic dye is distributed in continuous fashion within said continuous photochromic dye containing recipience layer, along at least 20%, at least 35%, at least 50%, at least 70%, or at least 95% of the (x-y) surface of the optical substrate.

Embodiment 204. The method of any one of the previous Embodiments, wherein, after said at least one photochromic dye containing ink has at least partially penetrated the upper surface of said dried recipience layer, the method further comprises repeating steps (a) and (b).

Embodiment 205. The method of Embodiment 204, wherein said repeating is performed at least 3 times.

Embodiment 206. The method of Embodiment 204, wherein said repeating is performed at least 10 times.

Embodiment 206A. The method of one of the previous Embodiments, further comprising drying the at least one photochromic dye containing ink or ink drops to form the photochromic dye containing recipience layer solely after the entire applying of the first photochromic dye onto the recipience surface has been completed.

Embodiment 206B. The method of one of the previous Embodiments, further comprising, after completing the applying of first photochromic dye of the wet recipience layer on the ophthalmic surface has been completed.

Embodiment 206C. The method of Embodiment 206A or 206B, wherein the drying is performed at a temperature above 30° C.

Embodiment 206D. The method of Embodiment 206A or 206B, wherein the drying is performed at a temperature below 120° C.

Embodiment 206E. The method of any one of Embodiments 206A to 206D, wherein the drying is performed at a temperature within a range of 45° C. to 95° C.

Embodiment 207. The method of one of the previous Embodiments, wherein, after said wet recipience layer has dried to form a dried recipience layer, said applying of said at least one photochromic dye containing ink onto said dried recipience layer is performed as a drop-on-drop application of said photochromic ink drops.

Embodiment 208. The method of one of the previous Embodiments, used to produce the article of any one of the Clauses provided below.

Clause 1. A photochromic optical article comprising: (a) an optical substrate having an optical surface; and (b) an optical construction including a polymeric recipience layer having a first surface fixedly attached to the optical surface, and a second surface disposed opposite the first surface; the polymeric recipience layer including (i) a polymer; (ii) a first photochromic dye, disposed within the recipience layer; (iii) a first softening agent disposed within the recipience layer, the softening agent adapted to soften the polymer; and an overcoat layer, coating the polymeric recipience layer, and fixedly attached to the second surface.

Clause 2. The article of Clause 1, wherein the optical substrate having an optical surface is an ophthalmic substrate having an ophthalmic surface.

Clause 3. The article of Clause 1 or 2, wherein:
optionally, at least one of the polymer and the polymeric recipience layer has a König hardness, measured in seconds, within a range of 30 to 200;
optionally, the pencil hardness of at least one of the polymer and the polymeric recipience layer is within a range of 2B to 4H;
optionally, the thickness (Toc) of the article is defined by the shortest distance or shortest normal distance between the substrate and the exterior surface of the article disposed distally to the substrate; wherein Toc is at most 175 μm; and
optionally, the ultimate elongation of the polymer is within a range of 20% to 475%.

Clause 4. The article of Clause 3, wherein a z direction is normal to the outer surface of the optical or ophthalmic article, and wherein, with respect to this z direction, the polymeric recipience layer has a first region and a second region, and wherein a second local hardness H2 in the second region exceeds a first local hardness H1 in the first region by a differential hardness, ê, according to: ê=100·(H2−H1)/H2.

Clause 5. The article of Clause 5, wherein ê is at least 2%.

Clause 6. The article of Clause 5, wherein ê is at least 4%.

Clause 7. The article of Clause 5, wherein ê is at least 6%.

Clause 8. The article of Clause 5, wherein ê is at least 8%.

Clause 9. The article of Clause 5, wherein ê is at least 10%.

Clause 10. The article of Clause 5, wherein ê is at least 12%.

Clause 11. The article of Clause 5, wherein ê is at least 15%.

Clause 12. The article of Clause 5, wherein ê is at least 20%.

Clause 13. The article of Clause 5, wherein ê is at least 25%.

Clause 14. The article of Clause 5, wherein ê is at least 35%.

Clause 15. The article of Clause 5, wherein ê is at least 50%.

Clause 16. The article of Clause 5, wherein ê is at least 70%.

Clause 17. The article of any one of Clauses 5 to 16, wherein ê is at most 97%.

Clause 18. The article of Clause 17, wherein ê is at most 90%.

Clause 19. The article of Clause 17, wherein ê is at most 80%.

Clause 20. The article Clause 4, wherein ê is within a range of 2 to 95%.

Clause 21. The article of Clause 20, wherein this range is 2 to 85%.

Clause 22. The article of Clause 20, wherein this range is 5 to 80%.

Clause 23. The article of Clause 20, wherein this range is 10 to 75%.

Clause 24. The article of Clause 20, wherein this range is 15 to 75%.

Clause 25. The article of Clause 20, wherein this range is 20 to 75%.

Clause 26. The article of Clause 20, wherein this range is 30 to 70%.

Clause 27. The article of any one of Clauses 5 to 26, wherein the differential hardness is a differential König hardness.

Clause 28. The article of any one of Clauses 4 to 27, wherein said differential hardness is a differential hardness as determined by indentation characterization.

Clause 29. The article of Clause 28, wherein said differential hardness is determined by nanoindentation.

Clause 30. The article of any one of Clauses 4 to 27, wherein the second local hardness, H2 in said second region exceeds said first local hardness, H1, in said first region by a differential pencil hardness, êHp of at least 1 standard pencil hardness unit.

Clause 31. The article of Clause 30, wherein êHp is at most 4 standard pencil hardness units.

Clause 32. The article of Clause 30, wherein êHp is at most 3 standard pencil hardness units.

Clause 33. The article of Clause 31 or 32, wherein êHp is at least 2 standard pencil hardness units.

Clause 34. The article of Clause 32, wherein êHp is within a range of 1 to 2 standard pencil hardness units.

Clause 35. The article of any one of Clauses 3 to 34, wherein the König hardness of at least one of the polymer and the polymeric recipience layer is at least 30.

Clause 36. The article of Clause 35, wherein this König hardness is at least 40.

Clause 37. The article of Clause 35, wherein this König hardness is at least 50.

Clause 38. The article of Clause 35, wherein this König hardness is at least 60.

Clause 39. The article of Clause 35, wherein this König hardness is at least 70.

Clause 40. The article of Clause 35, wherein this König hardness is at least 80.

Clause 41. The article of Clause 35, wherein this König hardness is at least 90.

Clause 42. The article of Clause 35, wherein this König hardness is at least 100.

Clause 43. The article of Clause 35, wherein this König hardness is at least 110.

Clause 44. The article of Clause 35, wherein this König hardness is at least 120.

Clause 45. The article of Clause 35, wherein this König hardness is at least 130.

Clause 46. The article of any one of Clauses 3 to 45, wherein this König hardness is at most 180.

Clause 47. The article of Clause 46, wherein this König hardness is at most 170.

Clause 48. The article of Clause 46, wherein this König hardness is at most 160.

Clause 49. The article of Clause 46, wherein this König hardness is at most 150.

Clause 50. The article of Clause 46, wherein this König hardness is at most 140.

Clause 51. The article of any one of the preceding Clauses, wherein the photochromic dye disposed within the polymeric recipience layer is a first portion P1 of the photochromic dye; a second portion P2 of the photochromic dye is disposed within the optical substrate, and a third portion P3 of said photochromic dye is disposed within the overcoat layer; and wherein a dye ratio defined by P1/(P2+P3) is at least 10.

Clause 52. The article of Clause 51, wherein the dye ratio is at least 20.

Clause 53. The article of Clause 50 or 51, wherein P2 is 0.

Clause 54. The article of any one of Clauses 51 to 53, wherein P3 is 0.

Clause 55. The article of any one of Clauses 3 to 54, wherein the ultimate elongation of the polymer is within a range of 20% to 475%.

Clause 56. The article of Clause 55, wherein the ultimate elongation of the polymer is at most 425%.

Clause 57. The article of Clause 55, wherein the ultimate elongation of the polymer is at most 350%.

Clause 58. The article of Clause 55, wherein the ultimate elongation of the polymer is at most 300%.

Clause 59. The article of Clause 55, wherein the ultimate elongation of the polymer is at most 250%.

Clause 60. The article of Clause 55, wherein the ultimate elongation of the polymer is at most 200%.

Clause 61. The article of Clause 55, wherein the ultimate elongation of the polymer is at most 175%.

Clause 62. The article of any one of Clauses 55 to 61, wherein the ultimate elongation of the polymer is at least 30%.

Clause 63. The article of Clause 62, wherein the ultimate elongation of the polymer is at least 40%.

Clause 64. The article of Clause 62, wherein the ultimate elongation of the polymer is at least 60%.

Clause 65. The article of Clause 62, wherein the ultimate elongation of the polymer is at least 80%.

Clause 66. The article of Clause 62, wherein the ultimate elongation of the polymer is at least 100%.

Clause 67. The article of any one of Clauses 1 to 66, wherein the thickness (Toc) of the article is defined by the shortest distance between the substrate and the exterior surface of the article disposed distally to the substrate, and wherein Toc is at most 60 μm.

Clause 68. The article of Clause 67, wherein Toc is at most 50 μm.

Clause 69. The article of Clause 67, wherein Toc is at most 45 μm.

Clause 70. The article of Clause 67, wherein Toc is at most 40 μm.

Clause 71. The article of Clause 67, wherein Toc is at most 35 μm.

Clause 72. The article of Clause 67, wherein Toc is at most 30 μm.

Clause 73. The article of Clause 67, wherein Toc is at most 25 μm.

Clause 74. The article of Clause 67, wherein Toc is at most 20 μm.

Clause 75. The article of Clause 67, wherein Toc is at most 15 μm.

Clause 76. The article of Clause 67, wherein Toc is at most 12 μm.

Clause 77. The article of Clause 67, wherein Toc is at most 10 μm.

Clause 78. The article of any one of Clauses 67 to 77, wherein Toc is at least 4 μm.

Clause 79. The article of Clause 78, wherein Toc is at least 6 μm.

Clause 80. The article of Clause 78, wherein Toc is at least 8 μm.

Clause 81. The article of Clause 67, wherein Toc is within a range of 5 to 45 μm.

Clause 82. The article of Clause 67, wherein Toc is within a range of 6 to 35 μm.

Clause 83. The article of Clause 67, wherein Toc is within a range of 7 to 30 μm.

Clause 84. The article of any one of Clauses 1 to 83, further comprising a first hardcoat layer, coating the overcoat layer, the first hardcoat layer fixedly attached to the side of the overcoat layer that faces the exterior surface of the article.

Clause 85. The article of Clause 84, the first hardcoat layer having a König hardness, measured in seconds, of at least 100.

Clause 86. The article of Clause 84, the first hardcoat layer having a König hardness, measured in seconds, of at least 110.

Clause 87. The article of Clause 84, the first hardcoat layer having a König hardness, measured in seconds, of at least 120.

Clause 88. The article of any one of Clauses 84 to 87, wherein the König hardness of the first hardcoat layer is at most 160.

Clause 89. The article of Clause 88, wherein the König hardness of the first hardcoat layer is at most 150.

Clause 90. The article of Clause 88, wherein the König hardness of the first hardcoat layer is at most 140.

Clause 91. The article of any one of Clauses 1 to 90, wherein the thickness (Trec) of the polymeric recipience layer is within a range of 0.6 to 30 μm.

Clause 92. The article of any one of Clauses 1 to 91, wherein the average thickness of the polymeric recipience layer (Trec-avg) is within a range of 0.6 to 30 μm.

Clause 93. The article of Clause 91 or 92, wherein at least one of Trec and Trec-avg is at least 1 μm.

Clause 94. The article of Clause 91 or 92, wherein at least one of Trec and Trec-avg is at least 1.5 μm.

Clause 95. The article of Clause 91 or 92, wherein at least one of Trec and Trec-avg is at least 2.5 μm.

Clause 96. The article of Clause 91 or 92, wherein at least one of Trec and Trec-avg is at least 3.5 μm.

Clause 97. The article of Clause 91 or 92, wherein at least one of Trec and Trec-avg is at least 5 μm.

Clause 98. The article of Clause 91 or 92, wherein at least one of Trec and Trec-avg is at least 6 μm.

Clause 99. The article of Clause 91 or 92, wherein at least one of Trec and Trec-avg is at least 8 μm.

Clause 100. The article of any one of Clauses 91 to 99, wherein at least one of Trec and Trec-avg is at most 25 μm.

Clause 101. The article of Clause 100, wherein at least one of Trec and Trec-avg is at most 20 μm.

Clause 102. The article of Clause 100, wherein at least one of Trec and Trec-avg is at most 15 μm.

Clause 103. The article of Clause 100, wherein at least one of Trec and Trec-avg is at most 12 μm.

Clause 104. The article of Clause 100, wherein at least one of Trec and Trec-avg is at most 10 μm.

Clause 105. The article of Clause 100, wherein at least one of Trec and Trec-avg is at most 8 μm.

Clause 106. The article of Clause 100, wherein at least one of Trec and Trec-avg is at most 6 μm.

Clause 107. The article of Clause 91, wherein Trec of the polymeric recipience layer is within a range of 1 to 18 μm.

Clause 108. The article of Clause 91, wherein Trec of the polymeric recipience layer is within a range of 1.5 to 9 μm.

Clause 109. The article of Clause 92, wherein Trec-avg of the polymeric recipience layer is within a range of 1 to 18 μm.

Clause 110. The article of Clause 92, wherein Trec-avg of the polymeric recipience layer is within a range of 1.5 to 9 μm.

Clause 111. The article of any one of Clauses 1 to 110, wherein the substrate is a lens (e.g., an eyeglass lens).

Clause 112. The article of any one of Clauses 1 to 111, wherein the substrate is a curved ophthalmic substrate having a SAG, wherein the absolute value of the SAG (|SAG|) is at least 0.5 mm.

Clause 113. The article of Clause 112, wherein |SAG| is at least 1 mm.

Clause 114. The article of Clause 112, wherein |SAG| is at least 2 mm.

Clause 115. The article of Clause 112, wherein |SAG| is at least 3.5 mm.

Clause 116. The article of Clause 112, wherein |SAG| is at least 5 mm.

Clause 117. The article of any one of Clauses 112 to 116, wherein |SAG| is at most 15 mm or at most 12 mm.

Clause 117A. The article of any one of Clauses 112 to 117, wherein the curved ophthalmic substrate is convex, such that the SAG is positive.

Clause 117B. The article of any one of Clauses 112 to 117, wherein the curved ophthalmic substrate is concave, such that the SAG is negative.

Clause 118. The article of any one of Clauses 1 to 117B, wherein the dried recipience layer has a pencil hardness of at most 4H.

Clause 119. The article of Clause 118, wherein the pencil hardness is at most 3H.

Clause 120. The article of Clause 118, wherein the pencil hardness is at most 2H.

Clause 121. The article of any one of Clauses 118 to 120, wherein the pencil hardness is 2B or harder.

Clause 122. The article of Clause 121, wherein the pencil hardness is B or harder.

Clause 123. The article of Clause 121, wherein the pencil hardness is HB or harder.

Clause 124. The article of Clause 121, wherein the pencil hardness is F or harder.

Clause 124. The article of Clause 121, wherein the pencil hardness is H or harder.

Clause 125. The article of any one of Clauses 1 to 124, wherein the substrate is or includes a thermoplastic substrate.

Clause 126. The article of Clause 125, wherein the thermoplastic substrate is or includes polycarbonate.

Clause 127. The article of any one of Clauses 1 to 126, wherein the substrate is or includes a thermoset substrate.

Clause 128. The article of any one of Clauses 1 to 128, wherein the overcoat layer is a hardcoat layer.

Clause 129. The article of Clause 128, wherein the hardcoat layer is an anti-scratch layer.

Clause 130. The article of Clause 128 or 129, wherein the hardcoat layer is, includes, or consists essentially of amorphous silica.

Clause 131. The article of any one of Clauses 1 to 130, further comprising a hardcoat layer, disposed above, and fixedly attached, to the overcoat layer.

Clause 132. The article of Clause 131, wherein the hardcoat layer is an anti-scratch layer.

Clause 133. The article of Clause 131 or 132, wherein the hardcoat layer is, includes, or consists essentially of amorphous silica.

Clause 134. The article of any one of Clauses 1 to 133, wherein the photochromic dye includes at least 2 photochromic dyes.

Clause 135. The article of any one of Clauses 1 to 134, further comprising a primer layer adhering to both the ophthalmic surface and to the first surface of the polymeric recipience layer, and disposed therebetween.

Clause 136. The article of Clause 135, wherein the primer layer has at least one of a spot thickness and an average thickness of at most 2.5 μm.

Clause 137. The article of Clause 135, wherein the primer layer has at least one of a spot thickness and an average thickness of at most 1.8 μm.

Clause 138. The article of Clause 135, wherein the primer layer has at least one of a spot thickness and an average thickness of at most 1.0 μm.

Clause 139. The article of any one of Clauses 136 to 138, wherein at least one of the spot thickness and the average thickness is at least 0.2 μm.

Clause 140. The article of any one of Clauses 136 to 138, wherein at least one of the spot thickness and the average thickness is at least 0.5 μm.

Clause 141. The article of any one of Clauses 1 to 140, further comprising an interior hardcoat layer disposed between the substrate and the polymeric recipience layer, the interior hardcoat layer adhering to the surface of the substrate.

Clause 142. The article of any one of Clauses 1 to 141, wherein the photochromic dye concentration (C_{recipience}) within the polymeric recipience layer is at least 3%.

Clause 143. The article of Clause 142, wherein C_{recipience} is at least 5%.

Clause 144. The article of Clause 142, wherein C_{recipience} is at least 8%.

Clause 145. The article of Clause 142, wherein C_{recipience} is at least 12%.

Clause 146. The article of Clause 142, wherein C_{recipience} is at least 18%.

Clause 147. The article of Clause 142, wherein C_{recipience} is at least 24%.

Clause 148. The article of Clause 142, wherein C_{recipience} is at least 30%.

Clause 148A. The article of Clause 142, wherein C_{recipience} is at least 36%.

Clause 149. The article of any one of Clauses 142 to 148, wherein C_{recipience} is at most 65%.

Clause 150. The article of Clause 149, wherein C_{recipience} is at most 60%, at most 55%, at most 50%, at most 45%, at most 42%, or at most 40%.

Clause 151. The article of any one of Clauses 1 to 150, wherein the photochromic dye concentration for the entire optical construction, Cₑₙₜᵢᵣₑ, is at least 2%.

Clause 152. The article of Clause 151, wherein Cₑₙₜᵢᵣₑ is at least 3.5%.

Clause 153. The article of Clause 151, wherein Cₑₙₜᵢᵣₑ is at least 5%.

Clause 154. The article of Clause 151, wherein Cₑₙₜᵢᵣₑ is at least 8%.

Clause 155. The article of Clause 151, wherein Cₑₙₜᵢᵣₑ is at least 12%.

Clause 156. The article of any one of Clauses 151 to 155, wherein Cₑₙₜᵢᵣₑ is at most 30% or at most 25%.

Clause 157. The article of Clause 156, wherein Cₑₙₜᵢᵣₑ is at most 22%.

Clause 158. The article of Clause 156, wherein Cₑₙₜᵢᵣₑ is at most 20%.

Clause 159. The article of Clause 156, wherein Cₑₙₜᵢᵣₑ is at most 18%.

Clause 160. The article of any one of Clauses 1 to 159, wherein the total thickness of dye, T_{dye}, is at least 0.25 μm.

Clause 161. The article of Clause 160, wherein T_{dye} is at least 0.5 μm. Clause 162. The article of Clause 160, wherein T_{dye} is at least 0.75 μm.

Clause 163. The article of Clause 160, wherein T_{dye} is at least 1.0 μm.

Clause 164. The article of Clause 160, wherein T_{dye} is at least 1.25 μm.

Clause 165. The article of any one of Clauses 160 to 164, wherein T_{dye} is at most 2 μm.

Clause 166. The article of Clause 165, wherein T_{dye} is at most 1.5 μm.

Clause 167. The article of any one of Clauses 1 to 166, wherein the haze value of the optical article, or of the optical construction, is at most 1.5%.

Clause 168. The article of Clause 167, wherein the haze value of the optical article, or of the optical construction, is at most 1.0%.

Clause 169. The article of Clause 168, wherein the haze value of the optical article, or of the optical construction, is at most 0.5%.

Clause 170. The article of any one of Clauses 1 to 169, wherein the shortest distance between the first surface and the optical surface is at most 10 μm.

Clause 171. The article of Clause 170, wherein this shortest distance is at most 5 μm.

Clause 172. The article of any one of Clauses 1 to 171, wherein the polymeric recipience layer contains at most 5% or at most 2%, by weight, or is substantially devoid of a 3-dimensional network such as amorphous silica nanoparticles.

Clause 173. The article of any one of Clauses 1 to 172, the article having a transparency of at least 90%, at least 92%, or at least 95%, according to ASTM D1746-15.

Clause 174. The article of any one of Clauses 1 to 173, wherein the optical surface is, or includes, the top or outwardly-facing surface of the optical substrate, and wherein optionally, the top or outwardly-facing surface has convex curvature.

Clause 175. The article of Clause 174, wherein the bottom or inwardly-facing surface has convex curvature.

Clause 176. The article of any one of Clauses 1 to 175, wherein the optical surface is, or includes, the bottom or inwardly-facing surface of the optical substrate, and wherein optionally, the bottom or inwardly-facing surface has concave curvature.

Clause 177. The article of Clause 176, wherein the bottom or inwardly-facing surface has concave curvature.

Clause 178. The article of any one of Clauses 1 to 177, wherein the optical surface includes a first, top optical surface and a second, bottom optical surface, wherein the optical construction includes a first, top optical construction and a second, bottom optical construction, and wherein the first, top optical surface is attached to the first, top optical construction and the second, bottom optical surface is attached to the second, bottom optical construction.

Clause 179. The article of any one of Clauses 1 to 178, further including any of the features in Embodiments 1 to 207.

Clause 180. The article of any one of Clauses 1 to 179, wherein the photochromic dye containing recipience layer is a continuous photochromic dye containing recipience layer.

Clause 180A. The article of any one of Clauses 1 to 180, wherein at least the first photochromic dye within the photochromic dye containing recipience layer forms a pattern.

Clause 180B. The article of Clause 180A, wherein the pattern is discernable to the naked eye.

Clause 180C. The article of Clause 180A or 180B, wherein the pattern forms an image.

Clause 180D. The article of any one of Clauses 180A to 180C, wherein the pattern forms lettering or at least one letter.

Clause 180E. The article of any one of Clauses 180A to 180D, wherein the pattern forms at least one logo.

Clause 180F. The article of any one of Clauses 180A to 180E, wherein the pattern forms a photochromic gradient.

Clause 180G. The article of any one of Clauses 180A to 180F, wherein the pattern forms a multi-colored photochromic gradient.

Clause 181. The article of any one of Clauses 180 to 180G, wherein the photochromic dye is distributed in continuous fashion within said continuous photochromic dye containing recipience layer, along the (x-y) surface of the optical substrate.

Clause 182. The article of Clause 181, wherein the photochromic dye is distributed in continuous fashion within said continuous photochromic dye containing recipience layer, along at least 20%, at least 35%, at least 50%, at least 70%, or at least 95% of the (x-y) surface of the optical substrate or surface.

Clause 183. The article of any one of Clauses 1 to 182, wherein the softening agent is selectively disposed in the x-y direction of the optical substrate or surface such that the photochromic dye containing recipience layer exhibits an uneven hardness in the x-y direction.

Clause 184. The article of Clause 183, the hardness being measured by indentation characterization such as nanoindentation, or by other means known in the art.

Clause 185. The article of Clause 183 or 184, wherein a first x-y region of the optical substrate has a first local hardness, and a second x-y region of the optical substrate has a second local hardness, the second local hardness exceeding the first local hardness by a differential hardness, ê, as defined by Embodiment 53.

Clause 186. The article of Clause 185, wherein ê is characterized by any of the features of Embodiments 53A to 75.

Clause 187. The article of any one of Clauses 183 to 186, wherein a or said first x-y region of the optical substrate has a first local hardness, and a or said second x-y region of the optical substrate has a second local hardness, the second local hardness exceeding the first local hardness by a differential pencil hardness, êHp.

Clause 188. The article of Clause 187, wherein ê is characterized by any of the features of Embodiments 76 to 80.

Clause 189. The article of any one of Clauses 1 to 188, wherein said first photochromic ink exhibits a first characteristic or intrinsic fading time (Tf1) and said second photochromic ink exhibits a second, different characteristic or intrinsic fading time (Tf2), and wherein the first and second photochromic inks are disposed within the first and second regions of local hardness so as to change (increase or more typically—decrease) a fading time differential (delta Tf=Tf1−Tf2) between said first and second photochromic inks within said recipience layer.

Clause 190. The article of Clause 189, wherein the fading time differential is decreased with respect to the intrinsic fading time differential by at least 2 seconds.

Clause 191. The article of Clause 190, wherein this decrease is at least 5 seconds.

Clause 192. The article of Clause 190, wherein this decrease is at least 10 seconds.

Clause 193. The article of Clause 190, wherein this decrease is at least 15 seconds.

Clause 194. The article of Clause 190, wherein this decrease is at least 20 seconds.

Clause 195. The article any one of Clauses 190 to 194, wherein this decrease is at most 50 seconds.

Clause 196. The article of Clause 190, wherein this decrease is at most 40 seconds.

Clause 197. The article of Clause 190, wherein this decrease is at most 30 seconds.

Clause 198. The article of Clause 190, wherein this decrease is at most 25 seconds.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, including U.S. Pat. No. 10,310,151, are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method of producing an ophthalmic construction, the method comprising:
(a) depositing a wet recipience layer on an ophthalmic surface of an ophthalmic substrate;
(b) after said wet recipience layer has cured sufficiently to form an at least partially cured recipience layer, applying at least a first photochromic ink, onto a recipience surface of said at least partially cured recipience layer;
wherein said first photochromic ink contains a first photochromic dye disposed within a first liquid medium, and a softening agent adapted to soften said at least partially cured recipience layer; and
(c) after said at least a first photochromic ink has at least partially penetrated the upper surface of said at least partially cured recipience layer, and after said at least a first photochromic ink has at least partially dried to form a photochromic dye containing recipience layer, applying a first polymer formulation on said photochromic dye containing recipience layer to form an overcoat layer;
wherein said applying of said first photochromic ink is performed selectively to produce a first region within said photochromic dye containing recipience layer that is relatively rich in said first photochromic dye, with respect to a second region within said photochromic dye containing recipience layer that is relatively poor in said first photochromic dye;
and wherein said applying of said first photochromic ink is performed selectively to produce an uneven hardness in said photochromic dye containing recipience layer, whereby a second local hardness in said second region exceeds a first local hardness in said first region.

2. The method of claim 1, further comprising, after said wet recipience layer has cured to form said at least partially cured recipience layer, applying, onto said recipience surface, at least a second photochromic ink containing a second photochromic dye disposed within said second liquid medium.

3. The method of claim 1 or claim 2, wherein the ultimate elongation of said wet recipience layer, after complete curing, is at most 350%.

4. The method of any one of claims 1 to 3, wherein the König hardness of said wet recipience layer, after complete curing, is at least 50.

5. The method of claim 4, wherein said König hardness is at least 80.

6. The method of any one of claims 1 to 5, wherein a weight content of said softening agent within said first photochromic ink is within a range of 1 to 15%.

7. The method of claim 6, wherein said weight content of said softening agent is at least 2%.

8. The method of any one of claims 1 to 7, wherein said softening agent is or includes a polymeric softening agent.

9. The method of any one of claims 1 to 7, wherein said softening agent is or includes a plasticizer.

10. The method of claim 9, wherein said plasticizer contains an ester.

11. The method of any one of claims 1 to 10, wherein said applying of said wet recipience layer is a digital applying of said wet recipience layer.

12. The method of any one of claims 1 to 11, wherein said applying of said wet recipience layer is performed according to a predetermined image pattern.

13. The method of any one of claims 1 to 12, wherein said applying of said at least a first photochromic ink onto said recipience surface is performed by depositing photochromic ink drops.

14. The method of claim 13, wherein, after said wet recipience layer has cured to form said at least partially cured recipience layer, said applying of said at least a first photochromic dye containing ink onto said at least partially cured recipience layer is performed as a drop-on-drop application of said photochromic ink drops.

15. The method of any one of claims 1 to 14, wherein, after said at least a first photochromic ink has at least partially penetrated the upper surface of said recipience layer, the method further comprises repeating steps (a) and (b).

16. The method of claim 15, wherein said repeating is performed at least 3 times.

17. The method of claim 15, wherein said repeating is performed at least 10 times.
